(19) United States
(12) Patent Application Publication
(10) Pub. No.: US 2007/0195251 A1
(43) Pub. Date: Aug. 23, 2007

(54) Systems for displaying images involving alignment liquid crystal displays

(75) Inventors: Ruibo Lu, Orlando, FL (US); Oi Hong, Orlando, FL (US); Shin-Tson Wu, Oviedo, FL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Toppoly Optoelectronics Corp.

(21) Appl. No.: 11/359,674

(22) Filed: Feb. 22, 2006

(51) Int. Cl. G02F 1/1343

(52) U.S. Cl. 349/143

(57) ABSTRACT

Systems for displaying images are provided. An exemplary system incorporates a vertical alignment liquid crystal display having a pixel unit. The pixel unit includes: a first substrate comprising a pixel layer thereon, wherein the pixel layer comprises a thin film transistor and a pixel electrode; a second substrate comprising a common electrode thereon; and a liquid crystal layer between the first and second substrates, wherein at least one of the pixel electrode and the common electrode has a plurality of holes therein, the holes being configured to align the liquid crystal layer.

### BACKGROUND OF THE INVENTION

1. Field of the Invention

The present invention generally relates to liquid crystal display devices.

2. Description of Related Art

Recently, liquid crystal display (LCD) devices have found wide applications in the large size monitor and TV markets. To realize a high quality LCD device, high transmittance, high contrast ratio and wide view angle are the main technical parameters that typically are required. Vertical alignment (VA) mode LCD devices in normally black mode can provide a sufficiently dark off-state, so it is relatively easy to fabricate a LCD device with high contrast ratio. To get the wide view range in VA mode, domain dividing structures typically are needed. Therefore, controlling the LC domains, i.e. the formation of multi-domain vertical alignment (MVA), is important, especially when voltage is applied. In addition, since a rubbing process can be avoided on the alignment layers in VA mode, it is beneficial for the high yield mass production of such devices.

Fujitsu Ltd. invented an MVA mode LCD device using physical protrusions. It was published in SID Technical Digest, vol. 29, p.1077(1998), Fujitsu Science Technical Journal, vol. 35, p. 221(1999), (see also U.S. Pat. No. 6,424,398). The chevron-patterned protrusions are created on the top and bottom substrates to form a four-domain LCD cells in multiple independent directions. The devices provide a high contrast ratio and a view angle wider than 160 degrees using biaxial compensation films. Since the horizontal gap between the upper and the lower protrusions are less than 30 m in order to obtain the good performance, pixel alignment needs high precision. Thus, the design specification and preparation process are not easy and the aperture ratio is limited.

International Business Machines (IBM) Corp. proposed a ridge and fringe-field multi-domain homeotropic (RFF-MH) mode, in which one substrate incorporates protrusions and the other incorporates slits to form the multi-domains. It was as published in Material Research Society Symposium Proceedings, vol. 559,p. 275 (1999), in U.S. Pat. No. 6,493,050. The device has a contrast ratio larger than 250:1 but requires higher driving voltage while the response time is longer.

As a simplified technology of the above MVA and RFF-MH technologies, Samsung Electronics Co. proposed the patterned vertical alignment (PVA) mode, in which only slits were used to produce the multi-domain structure under the electric fields. As described in their U.S. Pat. Nos. 6,285,431 and 6,570,638 , horizontal, vertical or oblique shaped slits were fabricated to form the zig-zag or W-shaped ITO patterning structure.

In the above mentioned modes, two linear polarizers are usually used. Iwamoto et al have reported an MVA mode using circular polarizers as published in the 9^{th} International Display Workshops, p. 85 (Hiroshima, Japan, Dec. 4-6, 2002) and Japanese Journal of Applied Physics, Vol. 41, p.L1383 (2002). In accordance with that disclosure, the light efficiency can be improved.

### SUMMARY OF THE INVENTION

Systems for displaying images are provided. An exemplary embodiment of such a system comprises: a vertical alignment liquid crystal display having a pixel unit comprising: a first substrate comprising a pixel layer thereon, wherein the pixel layer comprises a thin film transistor and a pixel electrode; a second substrate comprising a common electrode thereon; and a liquid crystal layer between the first and second substrates, wherein at least one of the pixel electrode and the common electrode has a plurality of holes therein, the holes being configured to align the liquid crystal layer.

Another exemplary embodiment of such a system comprises a vertical alignment liquid crystal display comprising pixel units, wherein each of a plurality of the pixel units comprises: a first substrate comprising a pixel layer thereon, wherein the pixel layer comprises a thin film transistor and a pixel electrode; a second substrate comprising a common electrode thereon; and a liquid crystal layer between the first and second substrates, wherein one of the pixel electrode and the common electrode has a cross-shaped opening therein, and the cross-shaped opening includes a central portion and extending portions extending from the central portion.

Still another exemplary embodiment of such a system comprises an electronic device comprising: a vertical alignment liquid crystal display having a pixel unit comprising: a first substrate comprising a pixel layer thereon, wherein the pixel layer comprises a thin film transistor and a pixel electrode; a second substrate comprising a common electrode thereon; and a liquid crystal layer between the first and second substrates, wherein at least one of the pixel electrode and the common electrode has a plurality of holes therein, the holes being configured to align the liquid crystal layer; and a controller electrically coupled to the display device.

It is to be understood that both the foregoing general description and the following detailed description are exemplary and explanatory only and are not restrictive of the invention, as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a drawing showing a VA mode LCD device according to an embodiment of the present invention.

FIG. 1B is a drawing showing another VA mode LCD device according to an embodiment of the present invention.

FIGS. 2-7 are drawings showing one pixel unit of a VA mode LCD device according to several embodiments of the present invention.

FIG. 8 shows a simulated LC director distribution of one pixel unit of the VA mode LCD device with double hexagon openings.

FIG. 9 shows the time-dependent transmittance comparison of conventional PVA mode with an embodiment of a VA mode LCD device having the double hexagon openings under the linear polarizers.

FIG. 10 shows the time-dependent transmittance of one pixel unit of an embodiment of a VA mode LCD device with the double hexagon openings under the circular polarizers.

FIG. 11 shows the iso-contrast contours of an embodiment of a VA mode LCD device between 0 Vᵣₘₛ and 5 Vᵣₘₛ using the double hexagon openings, wherein a set of a-plate and c-plate compensation films are added.

FIG. 12 shows a simulated LC director distribution of one pixel unit of an embodiment of a VA mode LCD device with the single hexagon openings.

FIG. 13 shows the time-dependent transmittance of one pixel unit of an embodiment of a VA mode LCD device with the single hexagon openings under linear and circular polarizers.

FIG. 14 shows the iso-contrast contours of an embodiment of a VA mode LCD device between 0 Vᵣₘₛ and 5 Vᵣₘₛ using the single hexagon openings, wherein a set of a-plate and c-plate compensation films are added.

FIG. 15 shows a simulated LC director distribution of one pixel unit of an embodiment of a VA mode LCD device with the double triangle openings.

FIG. 16 shows the time-dependent transmittance of one pixel unit of an embodiment of a VA mode LCD device with the double triangle openings under linear and circular polarizers.

FIG. 17 shows the iso-contrast contours of an embodiment of a VA mode LCD device between 0 Vᵣₘₛ and 5 Vᵣₘₛ using the double triangle openings, wherein an a-plate compensation film and a pair of a-plate and c-plate compensation films are added.

FIG. 18 shows a simulated LC director distribution of one pixel unit of an embodiment of a VA mode LCD device with the single triangle openings.

FIG. 19 shows the time-dependent transmittance of one pixel unit of an embodiment of a VA mode LCD device with the single triangle openings under linear and circular polarizers.

FIG. 20 shows the iso-contrast contours of an embodiment of a VA mode LCD device between 0 Vᵣₘₛ and 5 Vᵣₘₛ using the single triangle openings, wherein an a-plate compensation film and a pair of a-plate and c-plate compensation films are added.

FIG. 21 shows a simulated LC director distribution of one pixel unit of an embodiment of a VA mode LCD device with the double quadrangle openings.

FIG. 22 shows the time-dependent transmittance of one pixel unit of an embodiment of a VA mode LCD device with the double quadrangle openings under linear and circular polarizers.

FIG. 23 shows the iso-contrast contours of an embodiment of a VA mode LCD device between 0 Vᵣₘₛ and 5 Vᵣₛₘ using the double quadrangle openings, wherein an a-plate compensation film and a pair of a-plate and c-plate compensation films are added.

FIG. 24 shows a simulated LC director distribution of one pixel unit of an embodiment of a VA mode LCD device with the single quadrangle opening.

FIG. 25 shows the time-dependent transmittance of one pixel unit of an embodiment of a VA mode LCD device with the single quadrangle openings under linear and circular polarizers.

FIG. 26 shows the iso-contrast contours of an embodiment of a VA mode LCD device between 0 Vᵣₘₛ and 5 Vᵣₘₛ using the single quadrangle openings, wherein an a-plate compensation film and a pair of a-plate and c-plate compensation films are added.

FIGS. 27-34 are drawings showing one pixel unit of a VA mode LCD device according to several embodiments of the present invention.

FIG. 35 shows a simulated LC director distribution of one pixel unit of an embodiment of a VA mode LCD device with the cross-shaped opening of Example 7.

FIG. 36 shows the time-dependent transmittance comparison of conventional PVA mode with an embodiment of a VA mode LCD device having the cross-shaped opening of Example 7 under the linear polarizers.

FIG. 37 shows the time-dependent transmittance of one pixel unit of an embodiment of a VA mode LCD device with the cross-shaped opening of Example 7 under the circular polarizers.

FIG. 38 shows the iso-contrast contours of an embodiment of a VA mode LCD device between 0 Vᵣₘₛ and 5 Vᵣₘₛ using the cross-shaped opening of Example 7, wherein a set of a-plate and c-plate compensation films are added.

FIG. 39 shows a simulated LC director distribution of one pixel unit of an embodiment of a VA mode LCD device with the cross-shaped opening of Example 8.

FIG. 40 shows the time-dependent transmittance of one pixel unit of an embodiment of a VA mode LCD device with the cross-shaped opening of Example 8 under linear and circular polarizers.

FIG. 41 shows the iso-contrast contours of an embodiment of a VA mode LCD device between 0 Vᵣₘₛ and 5 Vᵣₘₛ using the cross-shaped opening of Example 8, wherein an a-plate compensation film and a pair of a-plate and c-plate compensation films are added.

FIG. 43 shows the time-dependent transmittance of one pixel unit of an embodiment of a VA mode LCD device with the cross-shaped opening of Example 9 under linear and circular polarizers.

FIG. 44 shows the iso-contrast contours of an embodiment of a VA mode LCD device between 0 Vᵣₘₛ and 5 Vᵣₘₛ using the cross-shaped opening of Example 9, wherein a set of a-plate and c-plate compensation films are added.

FIG. 45 shows a simulated LC director distribution of one pixel unit of an embodiment of a VA mode LCD device with the cross-shaped opening of Example 10.

FIG. 46 shows the time-dependent transmittance of one pixel unit of an embodiment of a VA mode LCD device with the cross-shaped opening of Example 10 under linear and circular polarizers.

FIG. 47 shows the iso-contrast contours of an embodiment of a VA mode LCD device between 0 Vᵣₘₛ and 5 Vᵣₘₛ using the cross-shaped opening of Example 10, wherein a set of a-plate and c-plate compensation films are added.

FIG. 48 shows a simulated LC director distribution of one pixel unit of an embodiment of a VA mode LCD device with the cross-shaped opening of Example 11.

FIG. 49 shows the time-dependent transmittance of one pixel unit of an embodiment of a VA mode LCD device with the cross-shaped opening of Example 11 under linear and circular polarizers.

FIG. 50 shows the iso-contrast contours of an embodiment of a VA mode LCD device between 0 Vᵣₘₛ and 5 Vᵣₘₛ using the cross-shaped opening of Example 11, wherein a set of a-plate and c-plate compensation films are added.

FIG. 51 shows a simulated LC director distribution of one pixel unit of an embodiment of a VA mode LCD device with the cross-shaped opening of Example 12.

FIG. 52 shows the time-dependent transmittance of one pixel unit of an embodiment of a VA mode LCD device with the cross-shaped opening of Example 12 under linear and circular polarizers.

FIG. 53 shows the iso-contrast contours of an embodiment of a VA mode LCD device between 0 Vᵣₘₛ and 5 Vᵣₘₛ using the cross-shaped opening of Example 12, wherein an a-plate compensation film and a pair of a-plate and c-plate compensation films are added.

FIG. 54 shows a simulated LC director distribution of one pixel unit of an embodiment of a VA mode LCD device with the cross-shaped opening of Example 13.

FIG. 55 shows the time-dependent transmittance of one pixel unit of an embodiment of a VA mode LCD device with the cross-shaped opening of Example 13 under linear and circular polarizers.

FIG. 56 shows the iso-contrast contours of an embodiment of a VA mode LCD device between 0 Vᵣₘₛ and 5 Vᵣₘₛ using the cross-shaped opening of Example 13, wherein an a-plate compensation film and a pair of a-plate and c-plate compensation films are added.

FIG. 57 shows a simulated LC director distribution of one pixel unit of an embodiment of a VA mode LCD device with the cross-shaped opening of Example 14.

FIG. 58 shows the time-dependent transmittance of one pixel unit of an embodiment of a VA mode LCD device with the cross-shaped opening of Example 14 under linear and circular polarizers.

FIG. 59 shows the iso-contrast contours of an embodiment of a VA mode LCD device between 0 Vᵣₘₛ and 5 Vᵣₘₛ using the cross-shaped opening of Example 14, wherein an a-plate compensation film and a pair of a-plate and c-plate compensation films are added.

FIG. 60 is a top view showing an embodiment of an electronic device according to an embodiment of the present invention.

### DESCRIPTION OF THE EMBODIMENTS

Before explaining the disclosed embodiments of the present invention in detail, it is to be understood that the invention is not limited in its application to the details of the particular arrangements shown since the invention is capable of other embodiments. Also, the terminology used herein is for the purpose of description and not of limitation.

Reference will now be made in detail to the present preferred embodiments of the invention, examples of which are illustrated in the accompanying drawings. Wherever possible, the same reference numbers are used in the drawings and the description to refer to the same or like parts.

### First Embodiment

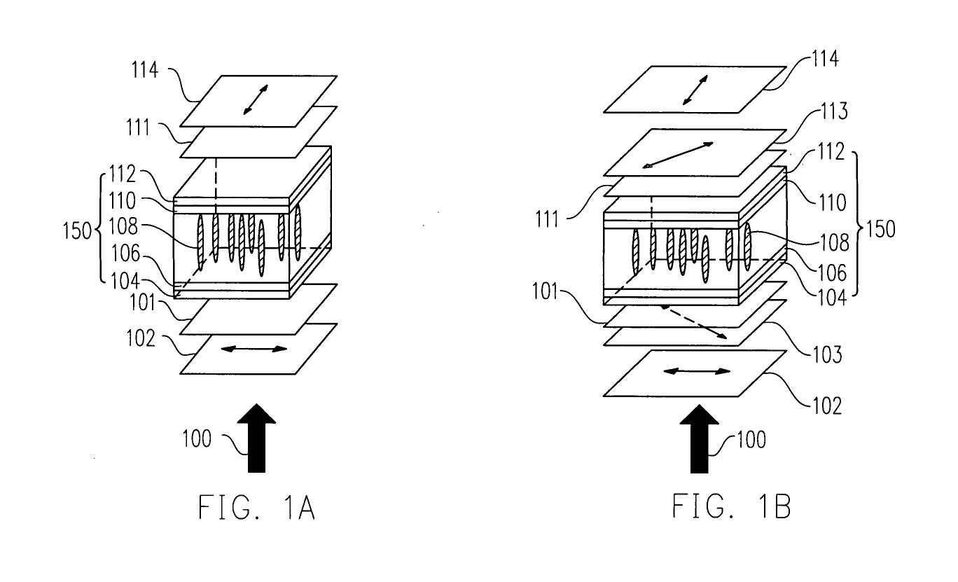

FIG. 1A is a drawing showing a system for displaying images that includes a vertical alignment liquid crystal display device according to an embodiment of the present invention. As shown in FIG. 1A, the vertical alignment liquid crystal display comprises a liquid crystal display panel 150, a first polarizer 102, a second polarizer 114 and a backlight module 100. As for the display device using the linear polarizers 102, 114, the included angle between the principle axes of the two polarizers 102, 114 are set at 90°, i.e. the polarizers are crossed. The liquid crystal display panel 150 includes a first substrate 104 having a pixel layer 106 thereon, a second substrate 112 having a common electrode 110 thereon and a liquid crystal layer 108. In this embodiment, the liquid crystal display panel 150 is rubbing-free and manufactured with simple preparation processes. Additionally, the liquid crystal layer 108 comprises negative dielectric (Δε<0) liquid crystal materials, for example. The liquid crystal layer 108 comprises nematic liquid crystal materials with chiral dopants in this embodiment; however, in other embodiments, the liquid crystal materials can exclude chiral dopants.

FIG. 1B shows another vertical alignment mode liquid crystal display device according to an embodiment of the present invention. The display of FIG. 1B uses circular polarizers. In other words, broadband quarter-wave films 103, 113 are placed adjacent the linear polarizers; that is, one is placed before polarizer 102 and the other is placed after linear polarizer 114. The included angle of the principal axis of first linear polarizer 102 and the first broadband quarter-wave film 103 is arranged at 45° to form the front circular polarizer. The polarizer has an assumed left-hand circularity, for example. Similarly, the included angle of the principal axis of second linear polarizer 114 and the second broadband quarter-wave film 113 is arranged at 45° to form the rear circular polarizer with corresponding right-hand circularity.

In addition, in FIG. 1A and FIG. 1B, the liquid crystal molecules of the liquid crystal layer 108 are homeotropically aligned without a rubbing process and the cell is in the VA mode at null voltage state. In these embodiments, each of the vertical alignment liquid crystal display of FIG. 1A and FIG. 1B further comprises optical films 101, 111 between the polarizers 102, 114 and the liquid crystal display panel 150. The optical films 101, 111 are compensation films, for example. These compensation films can be combinations of negative birefringence and uni-axial birefringence compensation films. The compensation films can also be biaxial compensation films and can be configured as a-plate or c-plate compensation films or a combination thereof.

The embodiments of the vertical alignment liquid crystal display of FIG. 1A and FIG. 1B further comprise two aligning layers (not shown), such as polymer layers or inorganic layers, wherein one of the aligning layers is disposed between the liquid crystal layer 108 and the pixel layer 106 on the first substrate 104, while the other aligning layer is disposed between the liquid crystal layer 108 and the common electrode 110 on the second substrates 112.

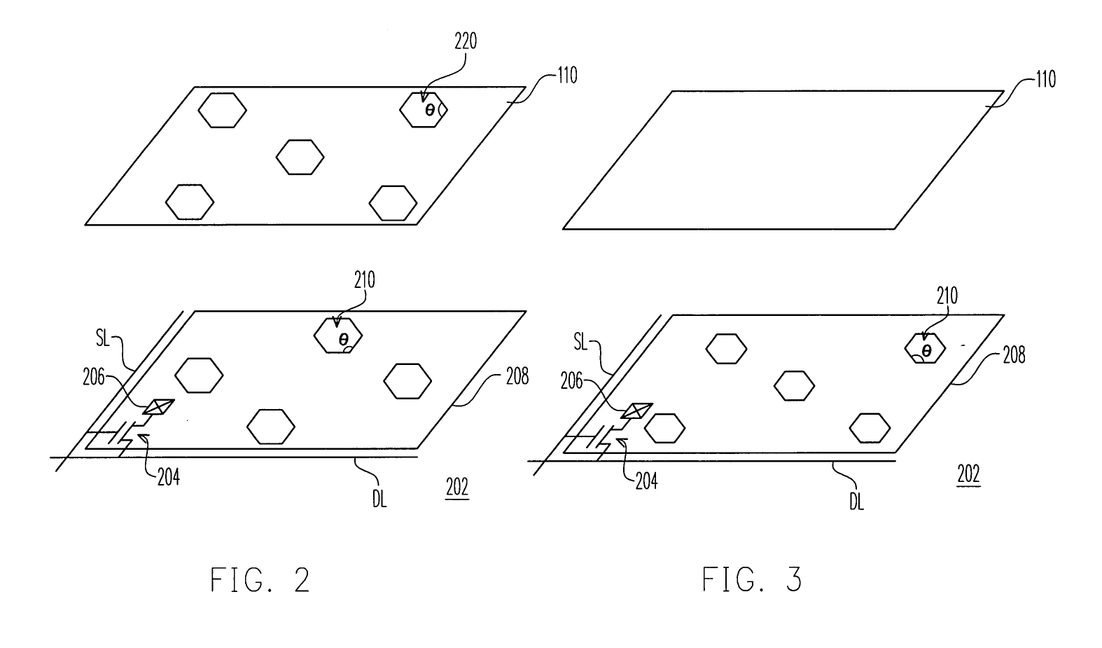

In the liquid crystal displays devices of FIG.1A and FIG.1B, a plurality of pixel units are repeatedly arranged in the liquid crystal display panel 150. FIG. 2 shows one of the pixel units of the liquid crystal display panel 150, wherein the liquid crystal layer and the first and second substrate are not shown in the figure.

In FIG. 2, the pixel layer 106 (FIGS. 1A and 1B) in one of the pixel units 202 comprises a scan line SL, a data line DL, a thin film transistor 204 and a pixel electrode 208. The scan line SL is electrically connected to a first terminal of the thin film transistor 204, the data line DL is electrically connected to a second terminal of the thin film transistor 204, and the pixel electrode 208 is electrically connected to a third terminal of the thin film transistor 204 through the contact 206, for example. In particular, the pixel electrode 208 has holes 210, such as hexagon openings, therein. In addition, one of the pixel units 202 on the second substrate 112 (FIG. 1A or FIG. 1B) comprises a common electrode 110, wherein the common electrode 110 also has holes 220, such as hexagon openings, therein. In particular, the hexagon openings 220 and the hexagon openings 210 are arranged so that openings in substrate 112 do not align vertically with the openings in electrode 208. The hexagon openings 210, 220 can be formed by photo-lithographing and etching process, for example. In some embodiments, a color filter layer (not shown) may be formed between the second substrate 112 and the common electrode 110. Hereinafter, since the hexagon openings 210, 220 are formed on both the substrates, such a device is referred to as a VA mode LCD device with the double hexagon openings.

As an example of the display device (FIG.1A) using the linear polarizers, when there is no voltage applied, the incident light is completely blocked by the crossed polarizers 102, 114 and an excellent dark state is obtained. When the voltage is applied, the fringe electric fields surrounding the pixel electrode and common electrode surfaces and the hexagon openings 210, 220 on the two substrates 104, 112 are created. The liquid crystal molecules in-between them with Δε<0 would be reoriented perpendicular to the electric field direction. Therefore, light propagates through the crossed linear polarizers 102, 114. Due to the fringe field effect from the substrates 104, 112 and the hexagon openings 210, 220, the liquid crystal molecules would tilt into different directions and triple domains in theory will be formed in the pixel unit. Therefore, a wide view angle is predicted. In addition, a contrast ratio >1000:1 could be achieved. The similar working mechanism is applicable to the display device (FIG. 1B) using the circular polarizers.

According to another embodiment, the hexagon openings may also be formed in one of the pixel electrode and the common electrode. As shown in FIG. 3, the hexagon openings 210 are formed in the pixel electrode 208. It should be noted that the hexagon openings may also be formed in the common electrode (not shown). Since hexagon openings are formed only on one of the two substrates, such a device is referred to as a VA mode LCD device with the single hexagon openings. The similar working mechanism as above mentioned is applicable to the display device with the single hexagon openings.

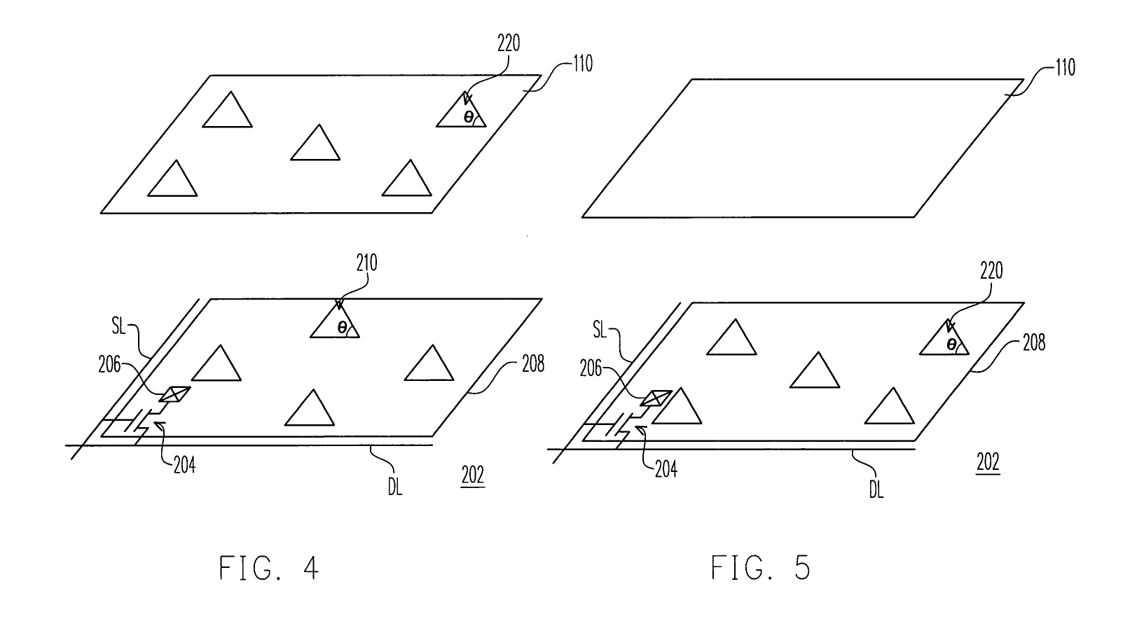

According to another embodiment, the openings formed in the pixel electrode and/or the common electrode may be triangle openings. As shown in FIG. 4, the triangle openings 210, 220 are formed in the pixel electrode 208 and the common electrode 110, and the triangle openings 210, 220 are arranged to not be aligned vertically. Similarly, the triangle openings may also be formed in one of the pixel electrode and the common electrode. As shown in FIG. 5, the triangle openings 210 are formed in the pixel electrode 208. It should be noted that the triangle openings may also be formed in the common electrode (not shown). The similar working mechanism as above mentioned is applicable to the display device with the double or single triangle openings.

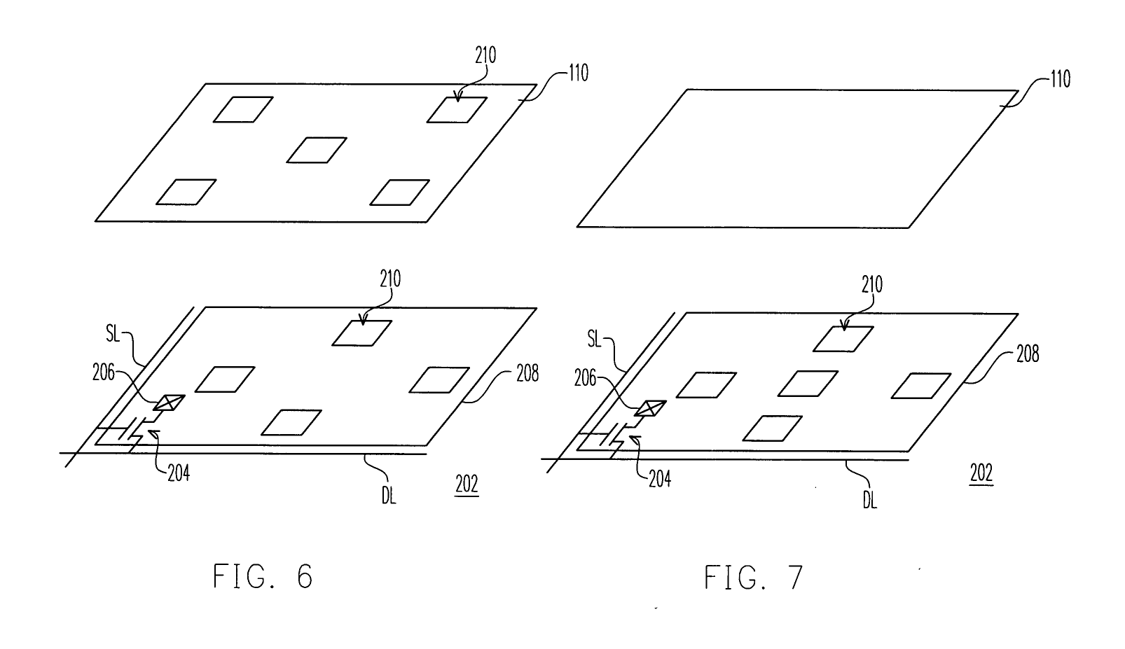

According to another embodiment, the openings formed in the pixel electrode and/or the common electrode may be quadrangle openings. As shown in FIG. 6, the quadrangle openings 210, 220 are formed in the pixel electrode 208 and the common electrode 110, and the quadrangle openings 210, 220 are arranged to not be aligned vertically. Similarly, the quadrangle openings may also be formed in one of the pixel electrode and the common electrode. As shown in FIG. 7, the quadrangle openings 210 are formed in the pixel electrode 208. It should be noted that the quadrangle openings may also be formed in the common electrode (not shown). The similar working mechanism as above mentioned is applicable to the display device with the double or single quadrangle openings.

For explanation and demonstration purposes, the following examples as indicated in FIGS. 3˜7 using Δε<0 liquid crystal materials with the linear polarizers and circular polarizers are described, respectively.

### EXAMPLE 1

The display device of FIG. 1A having linear polarizers and hexagon openings (as shown in FIG. 2) is described. The hexagon openings 210, 220 are formed in the pixel electrode 208 and the common electrode 110. The repeated pixel unit 202 size is 58·m×45·\tilde{m} The hexagon openings 210, 220 can be formed by etching or photo-lithographing during the TFT fabricating process. The tilt angle θ of the hexagon openings 210, 220 can be any non-zero value and the curvature of the hexagon openings can be acute angled, obtuse angled, half-circle or half-elliptical, among others. To get the symmetrically separated multi-domains, it would be better to choose the tilt angle θ at 120° with equal hexagonal outside length. The hexagonal length is 15·m. and the distance between the neighboring hexagon openings to the pixel electrode and common electrode is 25·m on the plan view. The cell gap between. the two substrates is 4·m. A negative LC mixture MLC-6608 (from Merck: birefringence ·n=0.083, dielectric anisotropy ··=−4.2 and rotational viscosity ·₁=0.186Pa·s) aligned vertical to the substrates in the initial state is used. Its azimuthal angle is 0°, and the pretilt angle is 90°.

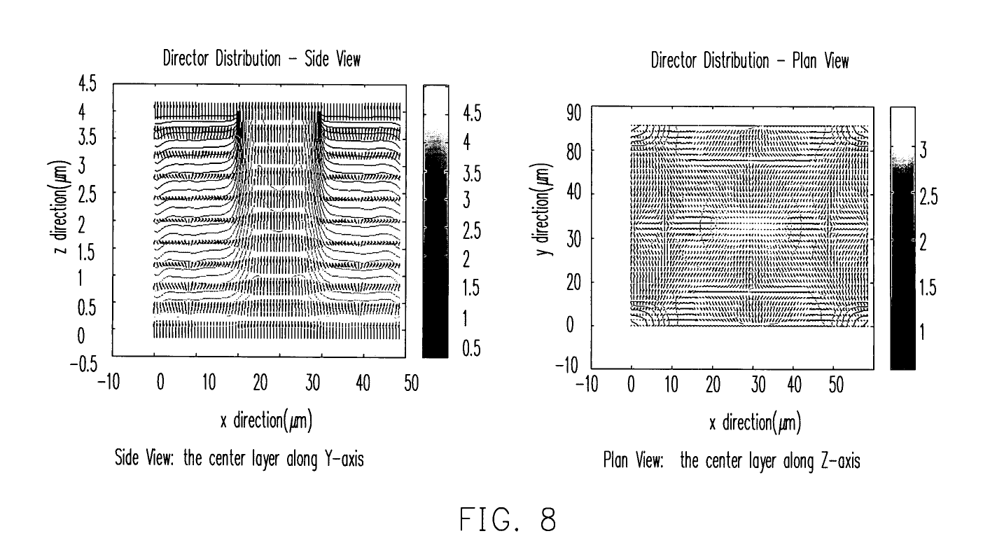

FIG. 8 is the simulated liquid crystal director distribution of Example 1 when the applied voltage is 5 Vᵣₘₛ between the common electrode and pixel electrode. The distribution is cut from the center layer of the LC cell gap and nearby the center of the pixel unit. From the side view, the LC directors are reoriented along the electric field direction due to the fringing field effect. In the regions of the discrete openings, the LC molecules are seldom influenced by the electric field which can form a barrier wall to stabilize the LC movement. It is useful in blocking the formation of the unstable disclination lines. On the plan view, the LC directors are divided into different evident domains in the pixel unit. Therefore, a multi-domain VA mode LCD device can be formed from the discrete hexagonal openings under the application of electric field. This structure helps to quickly stabilize the disclination lines.

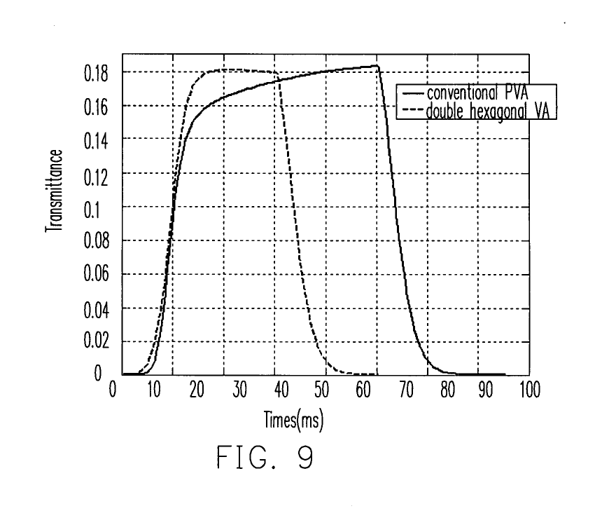

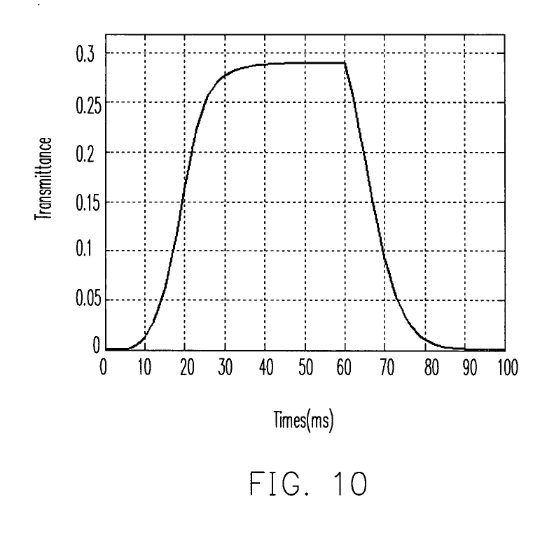

FIG. 9 shows the time-dependent transmittance comparison of a conventional PVA mode with an embodiment of a VA mode LCD device having the double hexagon openings under the linear polarizers. The conventional PVA mode LCD device has vertically staggered zig-zag openings on the substrates, and the negative LC mixture MLC-6608 was used at λ=550 nm under the linear polarizer configuration. In addition, the applied voltage is V=5 Vᵣₘₛ and the zig-zag opening width is 4·m. The conventional PVA mode has a lower transmittance (˜16.5%) at the 40 ms rise time although it will eventually reach the similar transmittance level. Even at 100 ms, the conventional PVA mode still has not reached the saturation level. Therefore, the double hexagonal VA mode of Example 1 has improved light efficiency by ˜9% over that of the conventional PVA mode. In addition, the VA mode LCD device of Example 1 shows a shorter delay time in the rise period and is faster to reach the saturated stable state. The typical rise time is about 20 ms, which is calculated from the transmittance rising from 10% to 90%. By contrast, the rise time of the conventional PVA mode is longer than 30 ms on the average.

To further improve the light transmittance of an embodiment of a VA mode LCD device , circular polarizers can be used. As shown in FIG. 10, the transmittance is greatly improved as compared to that of linear polarizers. The transmittance is increased from 18% for the linear polarizer configuration to 29% for the circular polarizer configuration. The improvement is as high as 61%. The maximum transmittance is 35% for the two polarizers alone. Thus, the embodiment of the multi-domain VA mode LCD. device exhibits a 82.9% (at 5 Vᵣₘₛ) normalized transmittance in comparison with that of a 90° TN LCD. The 90° TN LCD is known to have a rather limited viewing angle and is not regarded as suitable for LCD TV applications.

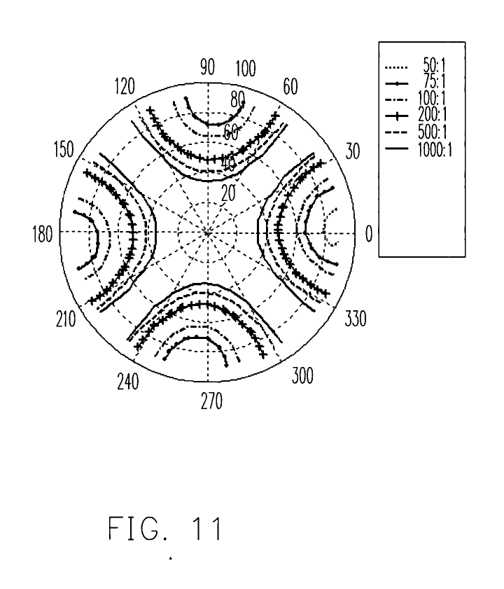

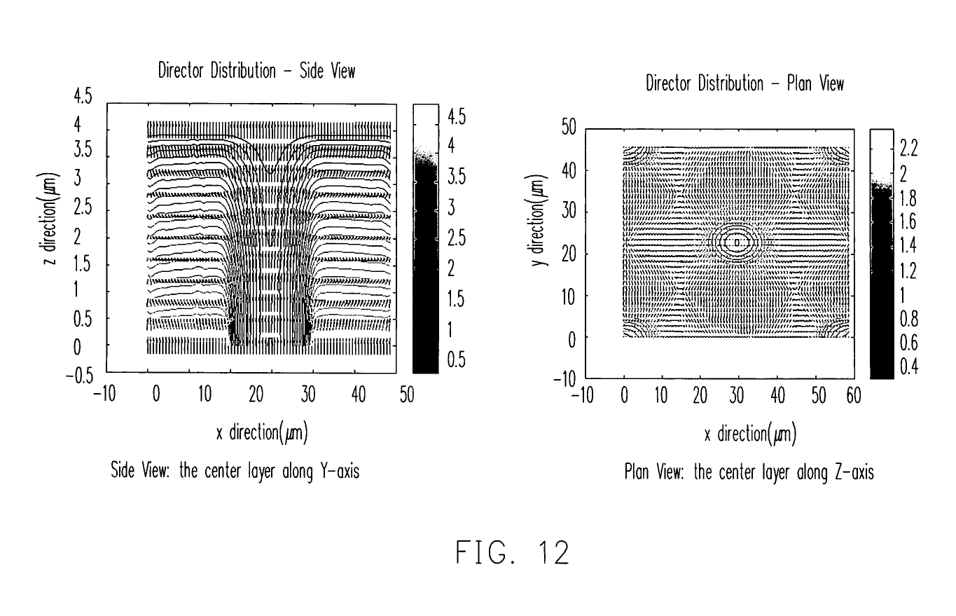

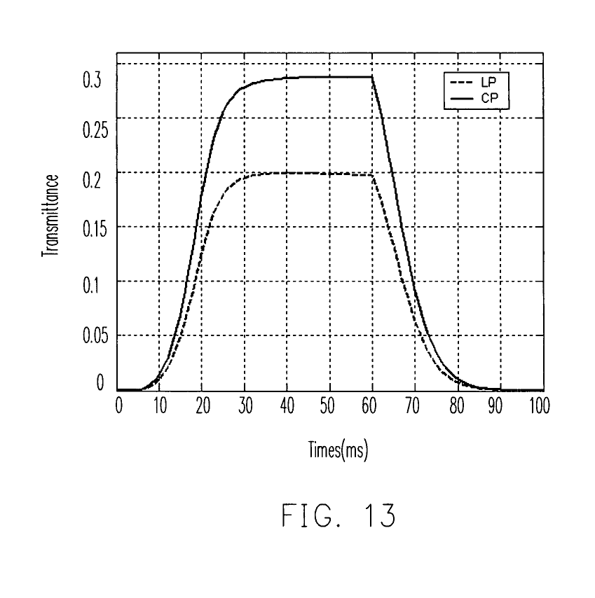

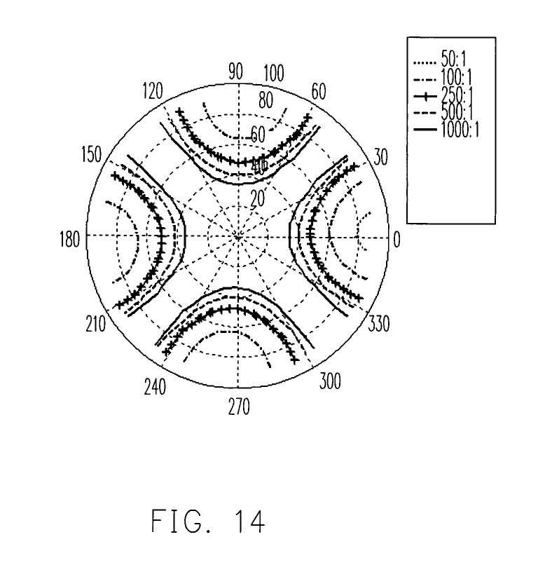

It has been known that a uniaxial and a negative birefringence films, or just biaxial films, are needed in order to widen the viewing angle of a VA cell. The detailed discussions can be found in a book by S. T. Wu and D. K. Yang, Reflective Liquid Crystal Displays (Wiley, Chichester, 2001). As an example, a pair of negative c-plate and positive a-plate is used as the compensation films to show the view angle characteristics of a VA mode LCD device under the linear polarizer configuration. A negative c-plate is a homogenous and uniaxial birefringence plate in which the optical axis is perpendicular to the surface of the plate with the birefringence nx=ny>nz. A positive a-plate is a homogenous and uniaxial birefringence plate in which the optical axis is parallel to the surface of the plate with the birefringence nx>ny=nz. A set of a-plate and c-plate compensation films with d ·n =98.1 nm and 12.2 nm, and 112.2 nm and 134.5 nm, respectively, are laminated in the inner side of the linear polarizer and analyzer. The contrast ratio is calculated between 0 and 5 Vrms. Results are shown in FIG. 11.

As shown in FIG. 11, a high contrast ratio is better than 1000:1 near the center area. The 1000:1 iso-contrast contour is wider than ±35° and fairly symmetric in all the directions. In the horizontal (say, 45°) and vertical (135°) directions, the viewing angle is very wide. The 100:1 iso-contrast contour line on both right-left and up-down viewing directions is wider than ±60°. On the whole range of ±80°, the contrast ratio is at 50:1. This demonstrates that such a device can exhibit excellent viewing angle characteristics. Therefore, embodiments of a hexagon VA mode LCD device have the potential to exhibit a high contrast ratio, wide view angle, improved transmittance, and faster response. Thus, such embodiments may be particularly beneficial for LC TV and monitor applications.

### EXAMPLE 2

An embodiment of a display device using linear polarizers or circular polarizers (FIGS. 1A or FIG. 1B) having and the hexagon openings 210 in the pixel electrode 208 (FIG. 3) is described. The other conditions, such as pixel unit size, tilt angle θ of the hexagon openings, hexagon opening length, cell gap between the two substrates, and LC materials, are the same or similar to that described in Example 1.

FIG. 12 shows the simulated LC director distribution of Example 2 at V=5 Vᵣₘₛ between the common electrodes and the pixel electrodes. From the side view, the LC directors are reoriented along the electric field direction due to the fringing field effect. The LC molecules above the opening regions are not reoriented by the electric field so that they form barrier walls to stabilize the LC movement and block the formation of the unstable disclination lines. On the plan view, the LC directors are divided into different evident domains in the pixel unit. Therefore, a multi-domain LCD device can be formed from the discrete hexagonal openings under the application of electric field.

FIG. 13 shows the time-dependent transmittance of one pixel unit of the VA mode LCD device with the single hexagon openings under linear polarizers (LP) and circular polarizers (CP). For the case of using linear polarizers, the transmittance of the VA mode LCD device reaches 20%. Light transmittance at the 60 ms rising stage is about 15% higher than that of the conventional PVA mode discussed in Example 1. In addition, the VA mode of Example 2 takes less time than the conventional PVA to reach saturation level during the rise period. Furthermore, the transmittance of the VA mode LCD device using circular polarizers reaches 31.8%, which is 59% improvement over the case of using linear polarizers. The normalized transmittance reaches 90.8% as compared to a 90° TN LCD at V=5 Vᵣₘₛ.

As an example, a set of a-plate and c-plate compensation films with d·n=97.9 mn and 12.4 nm, and 112.4 nm and 134.8 nm, respectively, are laminated in the inner side of the linear polarizer and analyzer. At V=0 and 5 Vᵣₘₛ, the LCD is in the dark and bright state, respectively. The contrast ratio is calculated between 0 and 5 Vᵣₘₛ As shown in FIG. 14, the contrast ratio is higher than 1000:1 in the central area. The 1000:1 iso-contrast contour line is larger than ±35° and symmetric in all directions. The 50:1 iso-contrast contour line extends to the ±80° viewing cone. Therefore, this embodiment of the VA mode LCD device shows superb viewing characteristics.

### EXAMPLE 3

An embodiment of a display device using linear polarizers or circular polarizers (FIGS. 1A or FIG. 1B) and having the triangle openings 210, 220 in the pixel electrode 208 and the common electrode 110 (FIG. 4) is described. To get the symmetrically separated multi-domains, it is better to choose an isosceles triangle (i.e., 60° angle and equal side length). For simulation purposes, the triangle side length is selected to be 15·m and the distance between the neighboring openings to the pixel electrode and common electrode is selected to be 28·m on the plane view. The other conditions, such as pixel unit size, cell gap between the two substrates, and LC materials, are similar to those described with respect to Example 1.

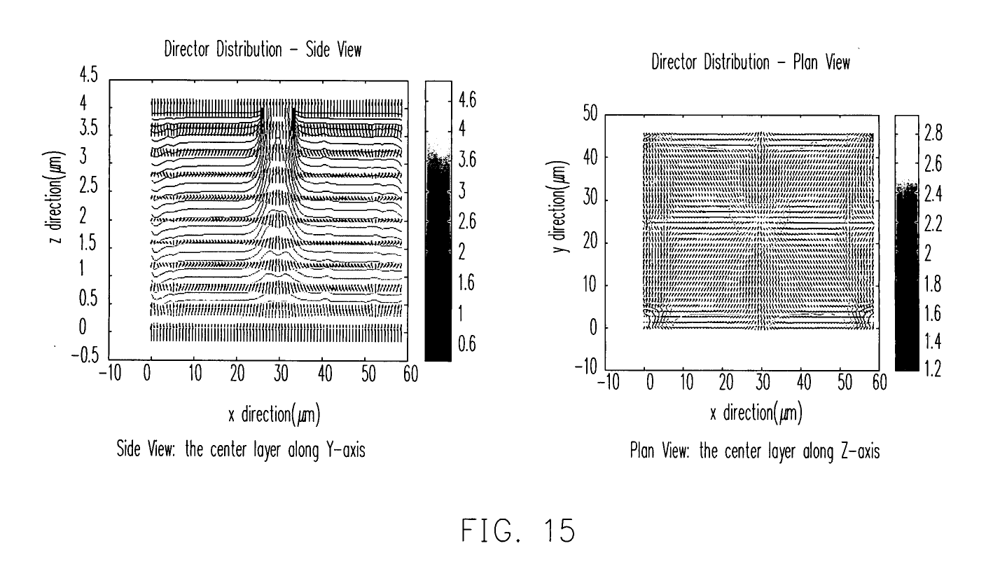

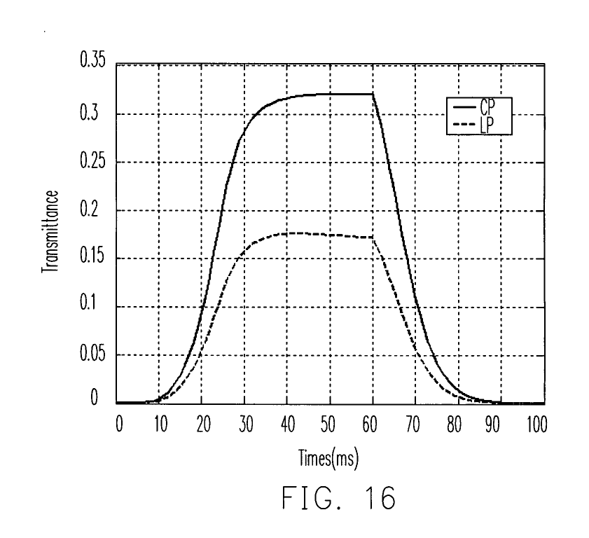

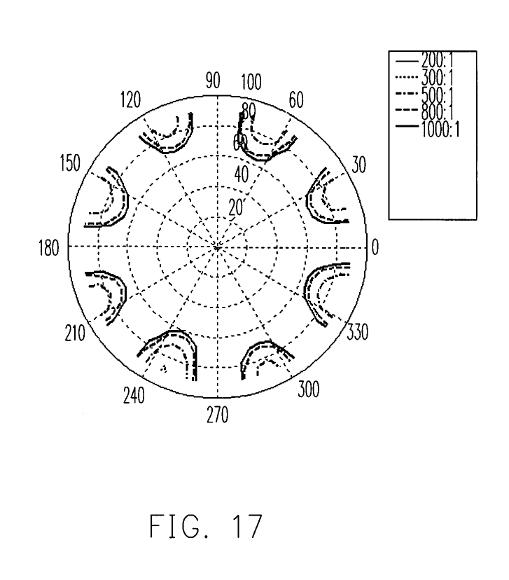

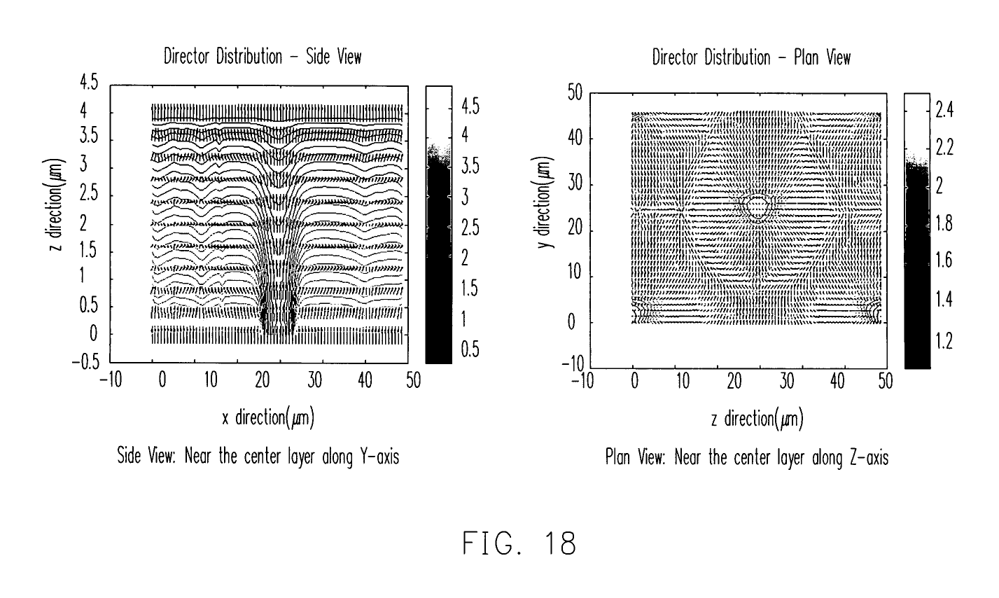

FIG. 15 shows the simulated LC director distribution of Example 3 at V=5 Vᵣₘₛ between the common electrodes and the pixel electrode. From the side view, it can be observed that the LC directors are reoriented along the electric field direction due to the fringing field effect. In the regions of the discrete openings, the LC molecules are rarely influenced by the electric field. Thus, they form a barrier wall to block the formation of the unstable disclination lines. On the plan view, the LC directors are divided into different evident domains in the pixel unit. Therefore, a multi-domain LCD device is formed from the discrete triangle openings under the application of electric field. These walls help to stabilize disclination lines and reduce LC response time.

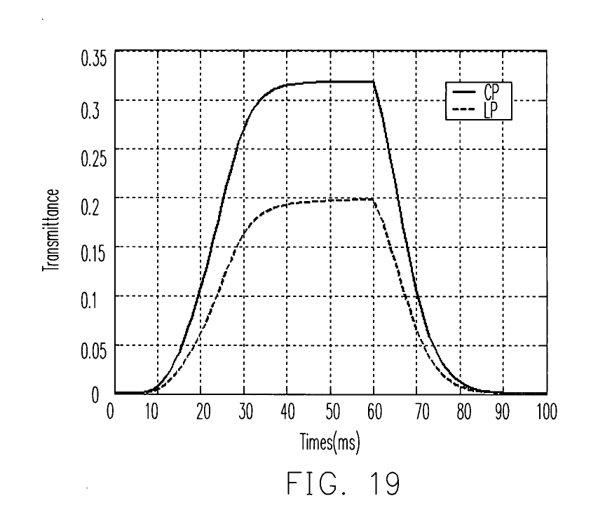

FIG. 16 shows the time-dependent transmittance of one pixel unit of the VA mode LCD device of Example 3 with the triangle openings under linear and circular polarizers. In the case of linear polarizers, the transmittance is 17.6%, which is still higher than that of the conventional PVA modes as discussed in Example 1. When the circular polarizers are used, the transmittance is increased to 32%; the improvement over the linear polarizer case is 81.8%. Therefore, the light transmittance of this embodiment of the VA mode can be greatly improved if the circular polarizers are adopted.

To calculate viewing angle, a uniaxial negative c-plate and positive a-plate are used as phase compensation films to the VA mode LCD device of Example 3. Herein, the linear polarizer configuration is considered, and the results for the circular polarizer configuration are very similar. An a-plate compensation film with d·n=119.7 nm is added after the linear polarizer, and a pair of a-plate and c-plate compensation films with d·n=64.5 nm and 168.7 nm are added before the linear analyzer. The contrast ratio is calculated between 0 and 5 Vᵣₘₛ. As shown in FIG. 17, the device has a high contrast ratio of 1000:1 in the range of ±70°. The 400:1 iso-contrast contour line on the right-left and up-down directions reaches out to ±80°. This indicates that even at ±80° viewing range, the display still has a 400:1 contrast ratio.

### EXAMPLE 4

An embodiment of a display device using linear polarizers or circular polarizers (FIGS. 1A or FIG. 1B) and having the triangle openings 210 in the pixel electrode 208 (FIG. 5) is described. The other conditions, such as pixel unit size, the triangle side length, cell gap between the two substrates, and LC materials, are the same or similar to those described in Example 3.

FIG. 18 is the simulated LC director distribution of Example 4 when the applied voltage is 5Vᵣₘₛ between the common electrode and pixel electrode. From the side view, the LC directors are reoriented along the electric field direction due to the fringing field effect. The LC molecules above the opening regions are seldom moved by the electric field which can form a barrier wall to stabilize the LC movement. It is useful to block the formation of the unstable disclination lines. On the plan view, the LC directors are divided into different evident domains in the pixel unit. Therefore, a multi-domain LCD is formed from the discrete triangle-shaped openings upon the application of electric field. The formed disclination lines reach equilibrium relatively quickly.

FIG. 19 shows the time-dependent transmittance of the VA mode LCD device of Example 4 under linear- and circular-polarizer. The transmittance of the VA mode LCD device under the linear-polarizer configuration is 20% which is higher than that of the conventional PVA mode as discussed in Example 1. If the circular polarizers are used, the transmittance is increased to 31.8% which is 59% improvement over the case of linear polarizers. Therefore, the light transmittance of this embodiment of the VA mode is greatly improved when the circular polarizers are adopted.

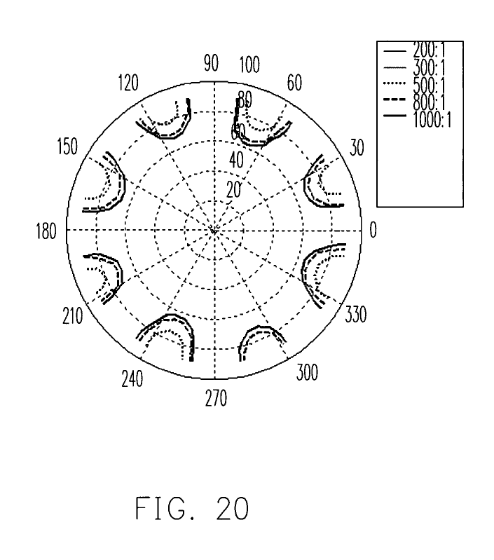

As an example, an a-plate compensation film with d·n=119.5 nm is added after the linear polarizer, and a pair of a-plate and c-plate compensation films with d·n =64.6 nm and 168.6 nm, respectively, is added before the linear analyzer. The contrast ratio is calculated between 0 and 5 Vᵣₘₛ. As shown in FIG. 20, the device has a high contrast ratio of 1000:1 in the ≅70° viewing cone. The iso-contrast contour of 400:1 on both right-left and up-down viewing directions reaches ±80°. This means that the device has a 400:1 contrast ratio within 160° viewing range. Therefore, this embodiment of the VA mode LCD device has a high contrast ratio and superb viewing characteristics.

### EXAMPLE 5

An embodiment of a display device using linear polarizers or circular polarizers (FIGS. 1A or FIG. 1B) and having the quadrangular openings 210, 220 in the pixel electrode 208 and the common electrode 110 (FIG. 6) is described. To get the symmetrically separated multi-domains, it is better to choose the discrete square openings having a side length at 8·m and the distance between the neighboring openings to the pixel electrode and common electrode is at 18·m on the plan view. The other conditions, such as pixel unit size, cell gap between the two substrates, and LC materials, are the same or similar to those described in Example 1.

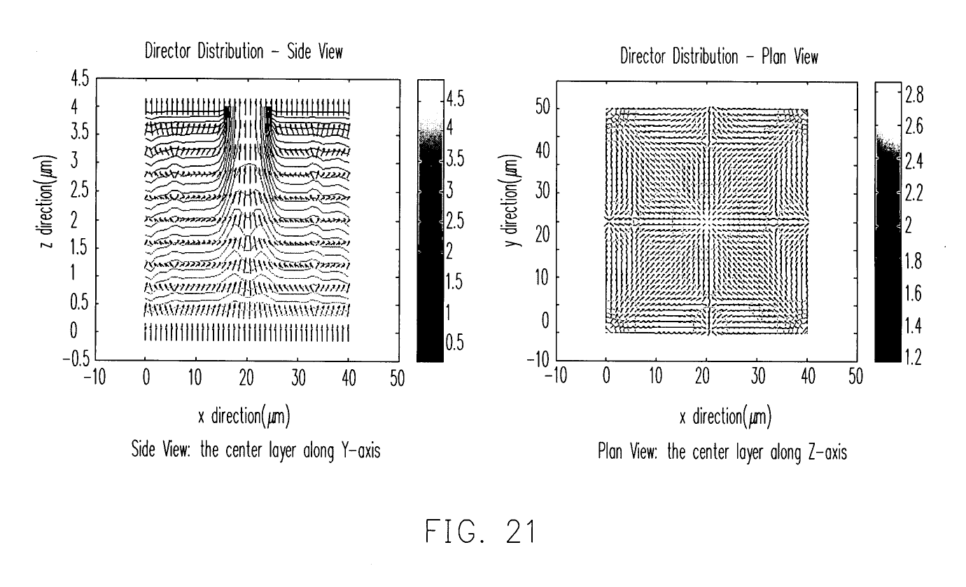

FIG. 21 is the simulated LC director distribution of Example 5 when the applied voltage is 5Vᵣₘₛ between the common electrode and pixel electrode. From the side view, it can be observed that the LC directors are reoriented along the electric field direction due to the fringing field effect. In the regions of the discrete openings, the LC molecules are seldom influenced by the electric field which can form a barrier wall to stabilize the LC movement. It is useful in blocking the formation of the unstable disclination lines. On the plan view, it can be seen that the LC directors have been divided into different evident domains in the pixel unit. Therefore, an embodiment of a multi-domain LCD device has been formed from the discrete quadrangle-shaped openings under the application of electric field and it has the potential of forming stable disclination lines.

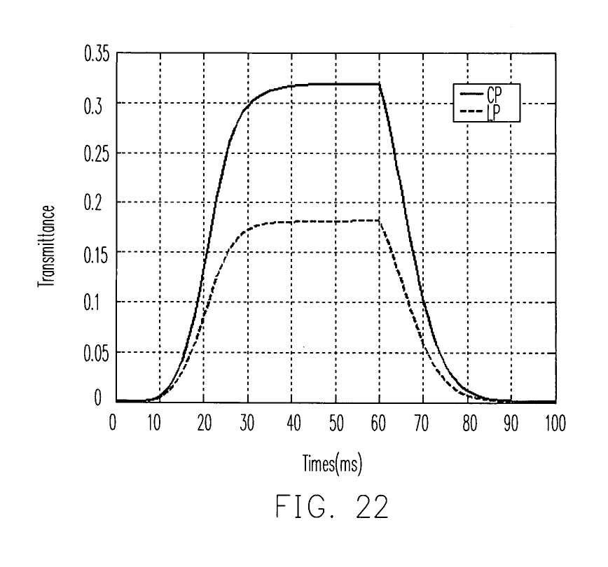

FIG. 22 is the time-dependent transmittance of the VA mode LCD device of Example 5 under linear polarizers and circular polarizers, respectively. The transmittance of the VA mode LCD device is 18.2% under linear polarizers which is higher than that of the conventional PVA modes as discussed in Example 1. If the circular polarizers are used, the transmittance is increased to 31.8% , which is 74.7% improvement over the case of linear polarizers. Therefore, the light transmittance of the VA mode is greatly improved when two circular polarizers are adopted. In addition, the rise time for both linear and circular polarizers configurations is less than 30 ms, which is faster than that of the conventional PVA mode.

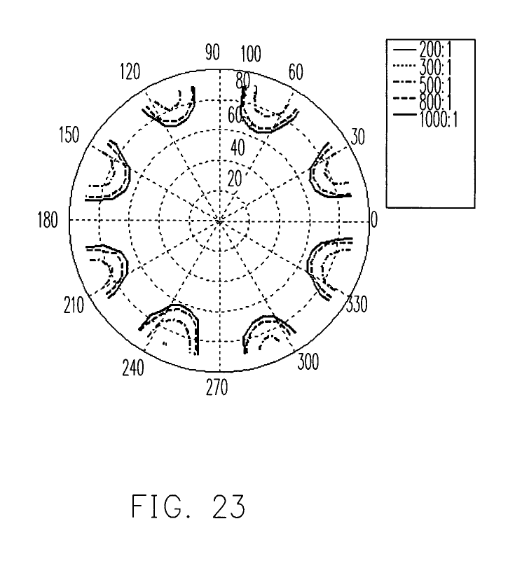

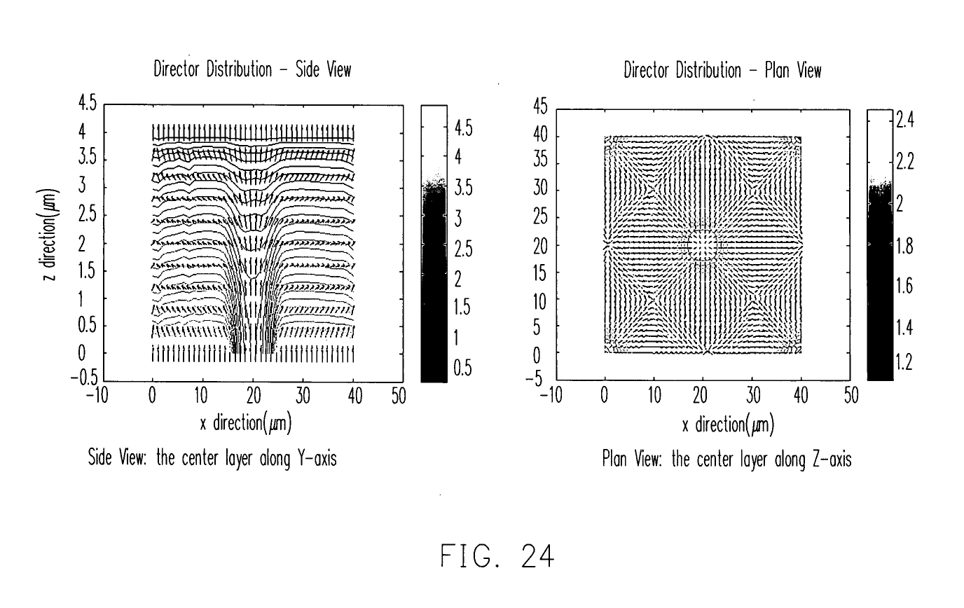

As the exemplary aim, an a-plate compensation film with d·n=119.2 nm is laminated in the inner side of the linear polarizer, and a pair of a-plate and c-plate compensation films with d·n=64.3 nm and 168.3 nm, respectively, is laminated in the inner side of the linear analyzer. The contrast ratio is calculated between 0 and 5Vᵣₘₛ. As shown in FIG. 23, the device has a 1000:1 contrast ratio in the 140° viewing range. The iso-contrast contour of 400:1 on both right-left and up-down directions reaches ±80°. This indicates that the device has a 400:1 contrast ratio within 1600 viewing range. Therefore, the embodiment of the VA mode LCD device has a high contrast ratio and superb viewing characteristics.

### EXAMPLE 6

An embodiment of a display device using linear polarizers or circular polarizers (FIG. 1A or FIG. 1B) and having the quadrangular openings 210 in the pixel electrode 208 (FIG. 7) is described. The other conditions, such as pixel unit size, quadrangular opening side length, cell gap between the two substrates, and LC materials, are the same or similar to those described in Example 5.

FIG. 24 is the simulated LC director distribution of Example 6 when the applied voltage is 5Vrms between the common electrode and pixel electrode. From the side view, the LC directors are reoriented along the electric field direction due to the fringing field effect. The LC molecules above the opening regions are rarely reoriented by the electric field. They form barrier walls to block the formation of the unstable disclination lines. On the plan view, the LC directors have been divided into different evident domains in the pixel unit. Therefore, an embodiment of a multi-domain VA mode LCD device is formed from the discrete quadrangle openings under the application of electric field and the formed disclination lines are stable.

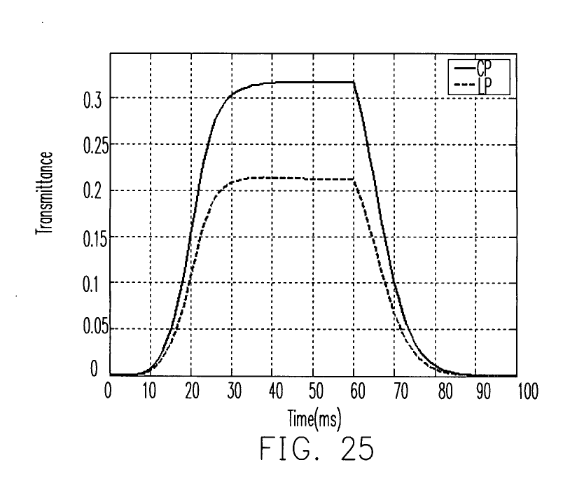

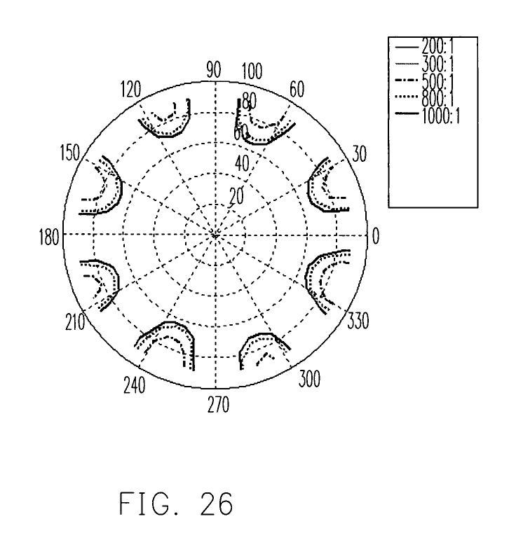

FIG. 25 is the time-dependent transmittance of the VA mode LCD device of Example 6 under the linear polarizers and the circular polarizers, respectively. The transmittance of the VA mode LCD device is 21.2% under the linear polarizers. Calculated at the rise time stage of 60 ms, it is 21.8% higher than that of the conventional PVA modes as discussed in Example 1. If circular polarizers are used, the transmittance is increased to 31.7% which is 49.5% improvement over the case of linear polarizers. Therefore, the light transmittance of the VA mode can be greatly improved when the circular polarizers are employed. In the meantime, the rise time under both linear polarizers and circular polarizers is about 25 ms, which is faster than that of the conventional PVA mode.

As the exemplary aim, an a-plate compensation film with d·n=119.4 nm is laminated in the inner side of the linear polarizer, and a pair of a-plate and c-plate compensation films with d·n=64.4 nm and 168.5 nm , respectively, is laminated in the inner side of the linear analyzer. The contrast ratio is calculated between 0 and 5 Vᵣₘₛ. As shown in FIG. 26, the device has a high contrast ratio of 1000:1 in the range of +70° viewing angle. The 400:1 iso-contrast contours on the right-left and up-down directions reach ±80°. This means that the device has a 400:1 contrast ratio within the ±80° viewing cone. In the ±70° viewing cone, the contrast ratio exceeds 1000:1. Since the embodiment of the VA mode LCD device has advantages in high transmittance, fast response time, superb view angle, high contrast ratio, and stable disclination line formation, it may be particularly beneficial for LC TV and monitor applications.

### Second Embodiment

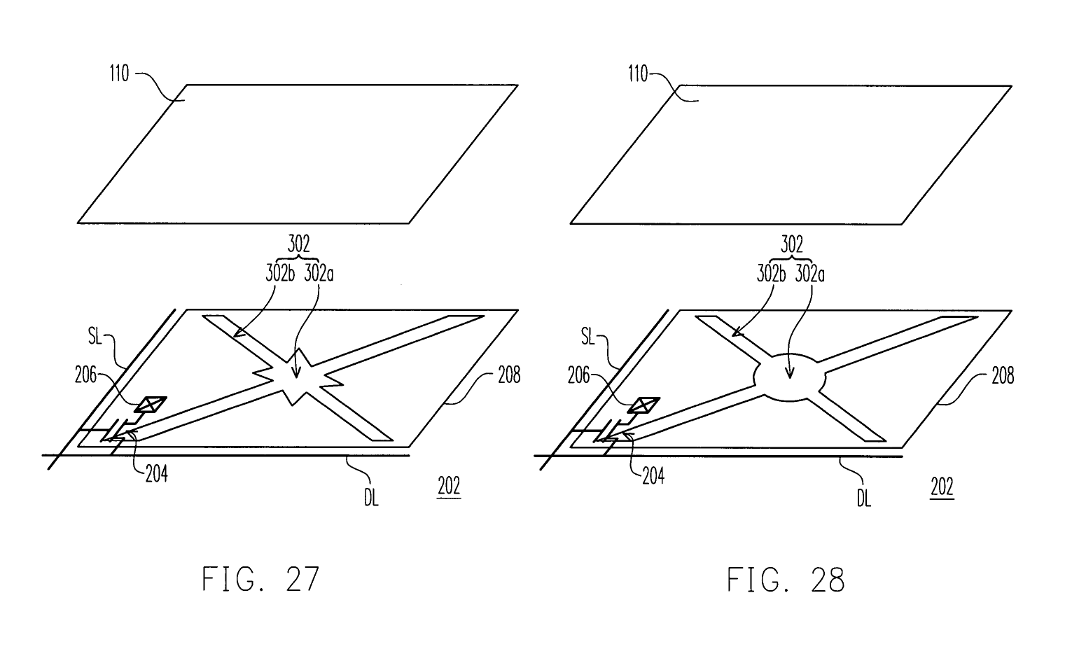

FIG. 27 shows one of the pixel units of the liquid crystal display panel 150 (FIG. 1A or FIG. 1B), wherein the liquid crystal layer is not shown in the figure. In FIG. 27, the pixel layer 106 (FIGS. 1A and 1B) in one of the pixel units 202 comprises a scan line SL, a data line DL, a thin film transistor 204 and a pixel electrode 208. Furthermore, one of the pixel units 202 on the second substrate 112 (FIG. 1A or FIG. 1B) comprises a common electrode 110. In some embodiments, a color filter layer (not shown) may be formed between the second substrate 112 and the common electrode 110.

In particular, a cross-shaped opening is formed in the pixel electrode 208 or the common electrode 110 in one pixel unit 202. For example, as shown in FIG. 27, the cross-shaped opening 302 is formed in the pixel electrode 208, wherein the cross-shaped opening 302 includes a central portion 302a and extending portions 302b extending from the center to the edges of the pixel unit. The cross-shaped opening 302 can be formed by photo-lithographing and etching process, for example. According to another embodiment, the cross-shaped opening may also be formed in the common electrode on the second substrate (not shown).

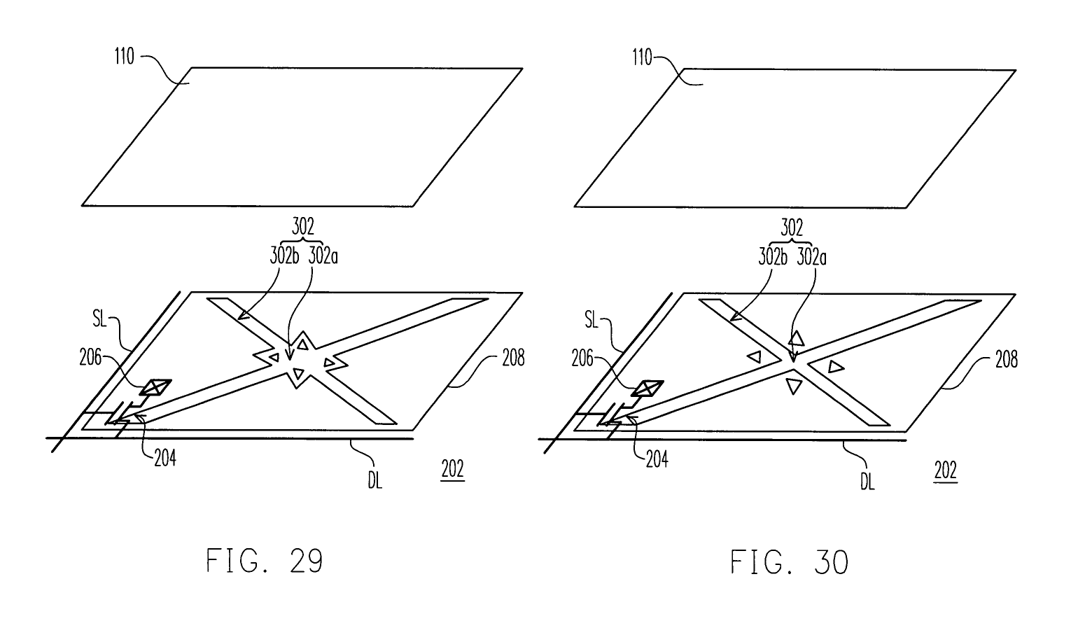

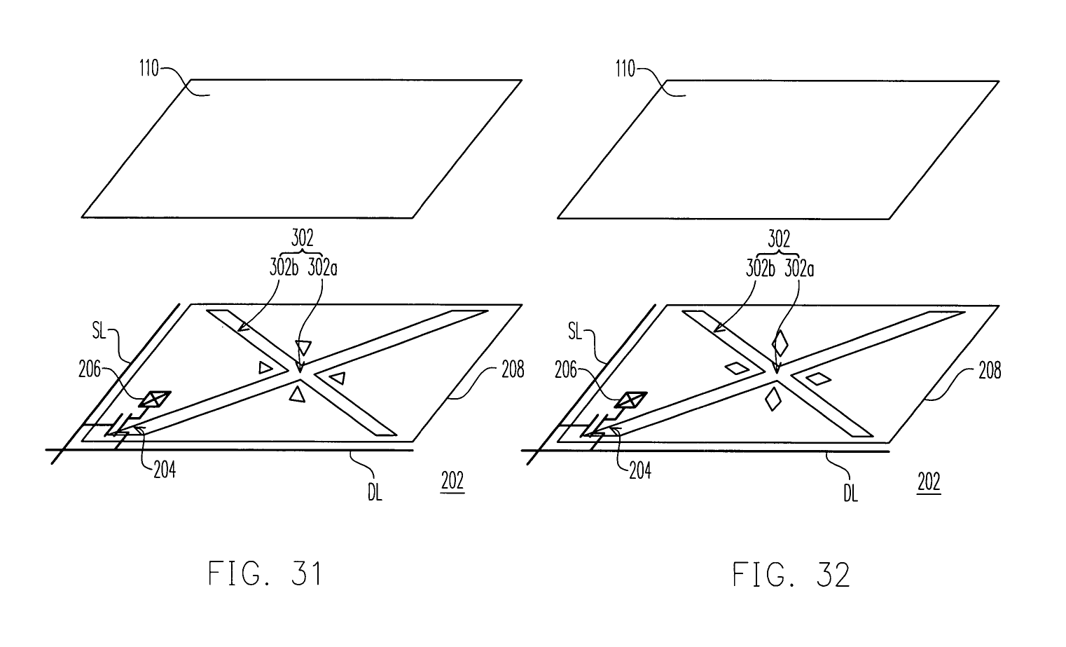

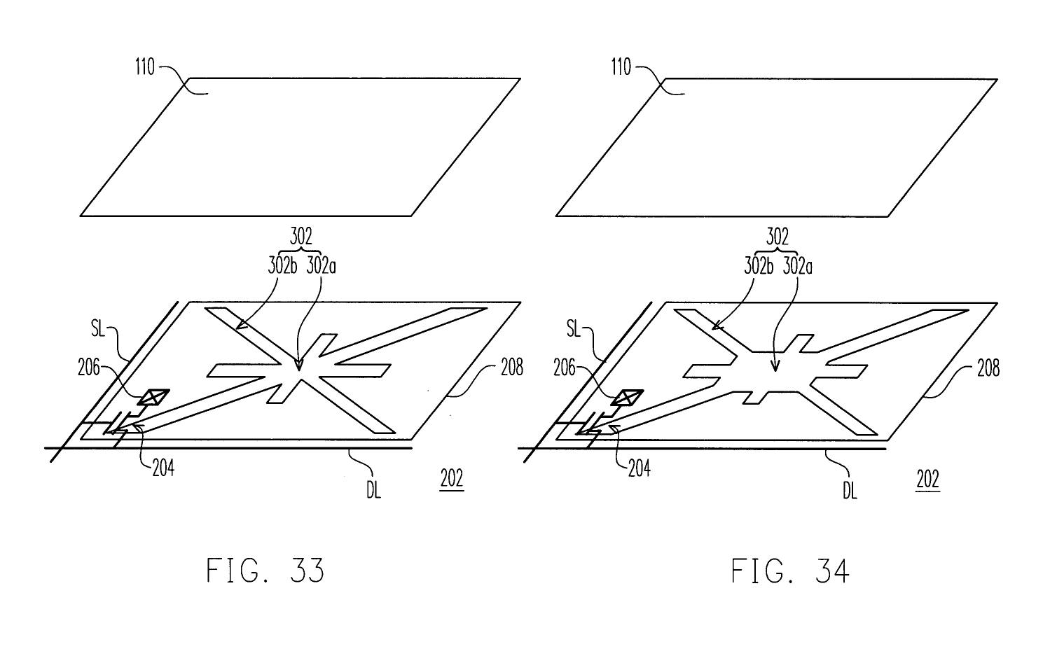

It should be noted that the central portion 302a can exhibit various shapes. For example, the central portion 302a can be constituted of a plurality of triangle-shaped openings, as shown in FIG. 27, in-between the neighboring crossed extending portions 302b. According to another embodiment, the central portion 302a may be a circular-shaped opening, as shown in FIG. 28. According to another embodiment, the central portion 302a can also be a series of ring-shaped openings around the center of the extending portions 302b, as shown in FIG. 29. According to another embodiment, the central portion 302a can also be a series of smaller intra-triangle openings around the center of the extending portions 302b, as shown in FIG. 30, and the tip of each intra-triangle opening is pointing away from the center of the pixel unit 202. According to another embodiment, the central portion 302a can be a series of smaller intra-triangle openings around the center of the extending portions 302b, as shown in FIG. 31, and the tip of each intra-triangle opening is pointing at the center of the pixel unit 202. According to another embodiment, the central portion 302a can be a series of smaller intra-quadrilateral openings around the center of the extending portions 302b, as shown in FIG. 32. According to another embodiment, the central portion 302a can also be a series of shorter stripe-shaped openings around the center of the extending portions 302b, as shown in FIG. 33. According to another embodiment, the central portion 302a can be constituted of a quadrangular opening in the center of the extending portions 302b and a series of shorter stripe-shaped openings connected with the quadrangular opening, as shown in FIG. 34.

For explanation and demonstration purposes, the following examples as indicated in FIGS. 27˜34 using Δε<0 liquid crystal materials with the linear polarizers and circular polarizers, respectively are described.

### EXAMPLE 7

An embodiment of a device of FIG. 1A having linear polarizers and the cross-shaped opening 302 in the pixel electrode 208 (as shown in FIG. 27) is described. In particular, the central portion 302a is constituted of a plurality of triangle-shaped openings in-between the neighboring crossed extending portions 302b. The repeated pixel unit size is 44·m×44·\tilde{m} The cross-shaped opening 302 can be formed by etching or photo-lithographing during the TFT preparation process. The width of the extending portions 302b is 4·m and the height of each triangle opening 302a is 12 μm calculated from the pixel center position with equal side length. The cell gap between the two substrates is 4·m. A negative LC mixture MLC-6608 (Merck Company: birefringence ·n=0.083, dielectric anisotropy ··=−4.2 and rotational viscosity ·₁=0.186Pa·s) aligned vertical to the substrates in the initial state is used. Its azimuthal angle is 0°, and the pretilt angle is 90°.

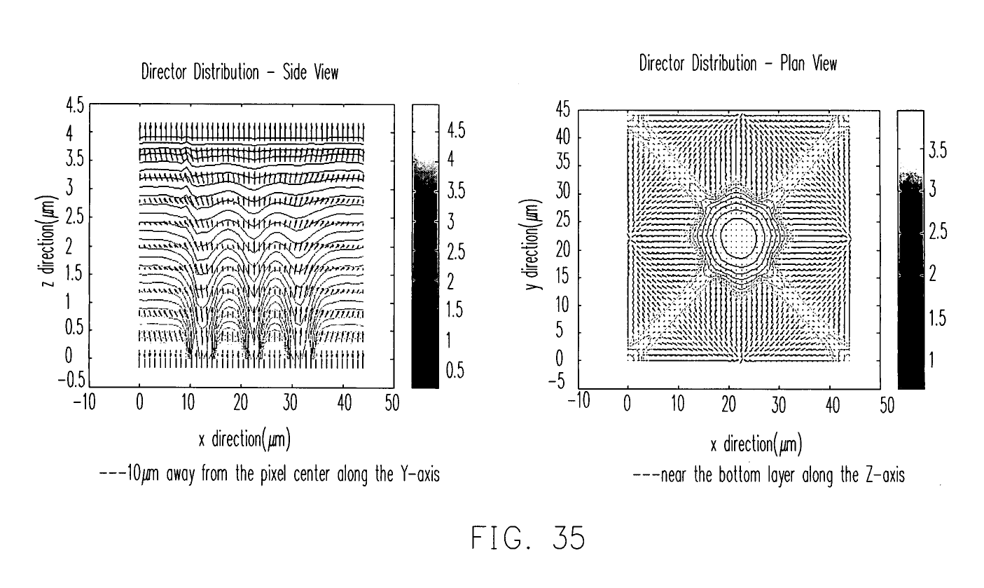

FIG. 35 is the simulated LC director distribution of Example 7 when the applied voltage is 5 Vᵣₘₛ between the common electrode and pixel electrode. From the side view, it can be observed that the LC directors are reoriented along the electric field direction due to the fringing field effect. On the plan view, it can be seen that the LC directors have been divided into different evident domains in the pixel unit. The domains are broken and met at the midpoint of each side of the tetragonal shaped pixels and the disclination lines are mostly eliminated. Therefore, an embodiment of a multi-domain LCD device has been formed from the cross-shaped opening under the application of electric field and it is nearly disclination-line free.

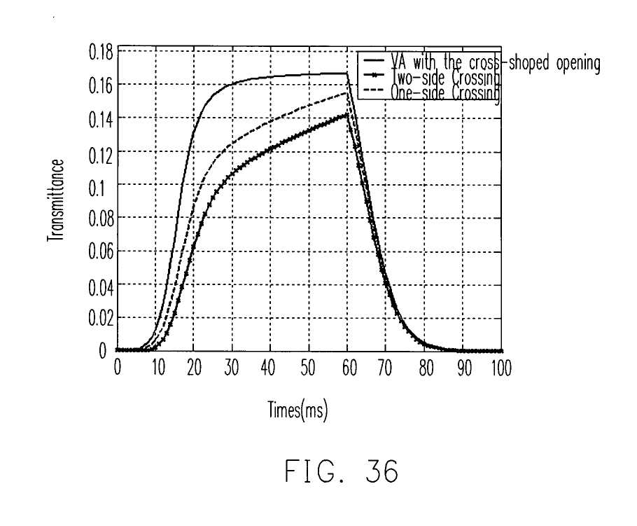

FIG. 36 shows the time-dependent transmittance comparison of conventional PVA modes with the VA mode LCD device having the cross-shaped opening of Example 7 under the linear polarizers. The openings of the conventional PVA modes are arranged on either the same substrate (one-side crossing) or two separate substrates respectively (two-side crossing). The negative LC mixture MLC-6608 was used at λ=550 nm under the linear polarizers. The applied voltage is V=5 Vᵣₘₛ and the opening width is 4·m. It can be seen that the conventional PVA modes have the lower transmittance of 15.5% and 14.2% at the rise time stage of 60 ms to the one-side crossing and the two-side crossing, respectively. At this time stage, the conventional PVA modes are still far from being saturated due to the instable disclination line formation. Therefore, the VA mode LCD device having the cross-shaped opening has a light intensity improvement of at least 8% than that of the conventional PVA modes. In addition, the device of Example 7 shows a shorter response delay in the rise period and is fast to get the saturated stable state when the pulse voltage is applied. It is beneficial to realize the fast response in the VA mode of Example 7. Its typical rise time is about 20 ms, which is calculated from the transmittance rising from 10% to 90%. It is much faster than the conventional PVA modes which will be longer than 30 ms on the average.

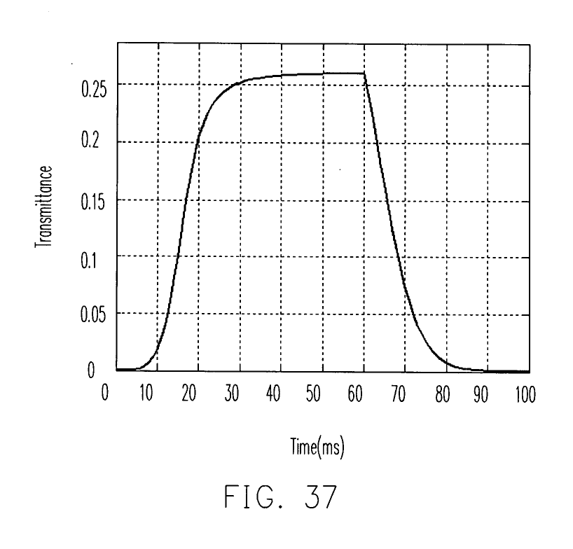

To further improve the light transmittance of the VA mode of the invention, the circular polarizers are used as shown in FIG.37. As shown in FIG.37, the transmittance has been greatly improved as compared to that of linear polarizers. The transmittance is 16.7% for the linear polarizers while it is increased to 26.1% under circular polarizers. A 56% improvement in transmittance has been obtained. For the two polarizers alone, the maximum transmittance is 35%. Thus, this embodiment of the multi-domain VA cell exhibits 74.6% (at 5Vᵣₘₛ) normalized transmittance as compared to that of a 90° TN LCD.

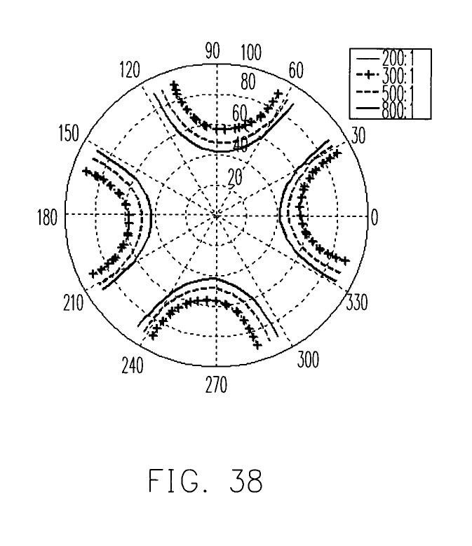

As an example, a set of a-plate and c-plate compensation films are added at the d·n value of 98 nm and 12.3 nm, and 112.4 nm and 134.7 nm, before and after the linear polarizer and analyzer respectively. The contrast ratio is calculated between 0 Vᵣₘₛ and 5 Vᵣₘₛ. As shown in FIG. 38, the device has a high contrast ratio nearby the center area that is better than 800:1. The iso-contrast contour of 800:1 is larger than ±40° and symmetric to all the directions. The iso-contrast contour of 100:1 on both the right-left region and the up-down region has been reaching out of ±800°, which demonstrates that the device has a wide view angle of above 160° even with an excellent contrast ratio of 100:1. Therefore, this embodiment of the VA mode LCD device has a high contrast ratio of 800:1 and the very wide view angle ability. In combination with the advantages of its higher transmittance, faster response, super-wide view angle and high contrast ratio, this embodiment of the VA mode LCD device having the cross-shaped opening may be particularly beneficial for LC TV and monitor applications.

### EXAMPLE 8

An embodiment of a display device using linear polarizers or circular polarizers (FIGS. 1A or FIG. 1B) and having the cross-shaped opening 302 in the pixel electrode 208 (FIG. 28) is described, wherein the central portion 302a of the cross-shaped opening 302 is a circular-shaped opening and the radius of the circular-shaped opening is at 12 μm calculated from the pixel center position. The other conditions, such as pixel unit size, extending portion width, cell gap between the two substrates, and LC materials, are the same or similar to those described in Example 7.

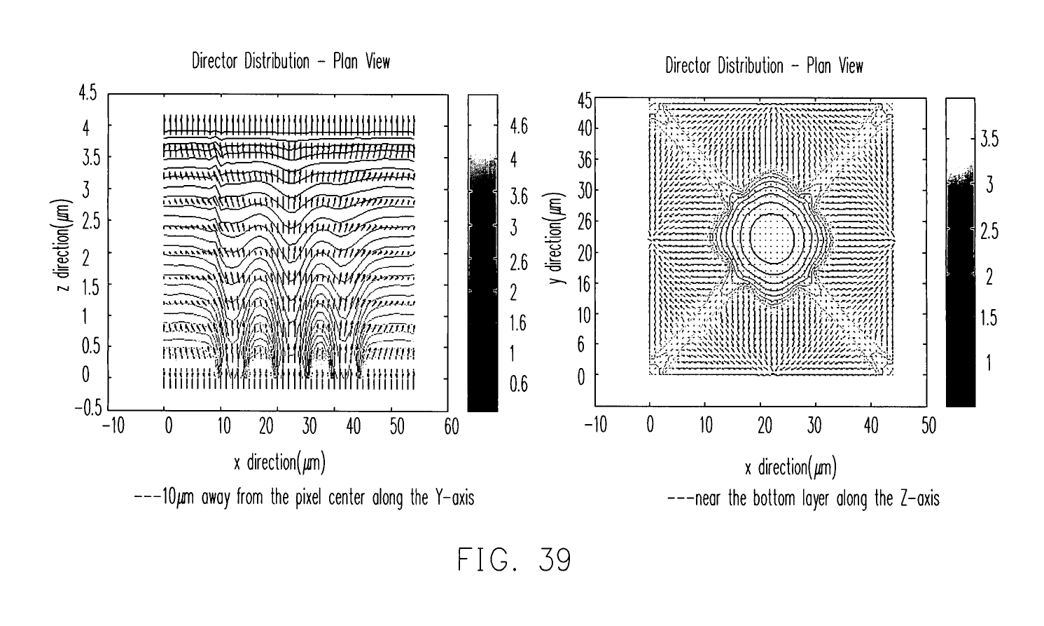

FIG. 39 is the simulated LC director distribution of Example 8 when the applied voltage is 5 Vᵣₘₛ between the common electrode and pixel electrode. From the side view, it can be observed that the LC directors are reoriented along the electric field direction due to the fringing field effect. On the plan view, it can be seen that the LC directors have been divided into different evident domains in the pixel unit. The domains are broken and met at the midpoint of each side of the tetragonal shaped pixels and the disclination lines are mostly eliminated. Therefore, an embodiment of a multi-domain VA mode LCD device has been formed from the cross-shaped opening under the application of electric field and it is nearly disclination-line free.

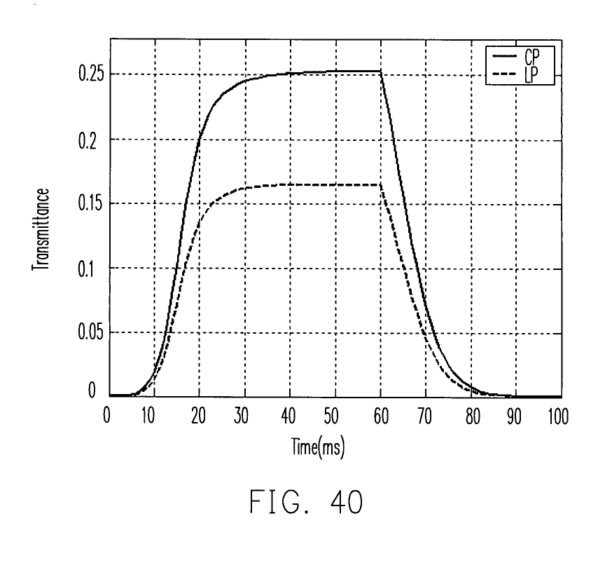

FIG. 40 is the time-dependent transmittance of the VA mode LCD device of Example 8 under the linear polarizers and the circular polarizers, respectively. The transmittance of the VA mode LCD device is 16.5% under the linear polarizers which is higher than that of the conventional PVA modes as discussed in Example 7. It is quick to reach its saturation stage during the rise period in realizing a faster response time. In addition, the transmittance of the device with the circular polarizers has been greatly improved as compared to that of the linear polarizers. The transmittance has increased to 25.3% under the circular polarizers, which is 53.3% improvement than that of the linear polarizers. It exhibits 72.3% normalized transmittance as compared to that of a 90° TN LCD when the applied voltage is 5 Vᵣₘₛ.

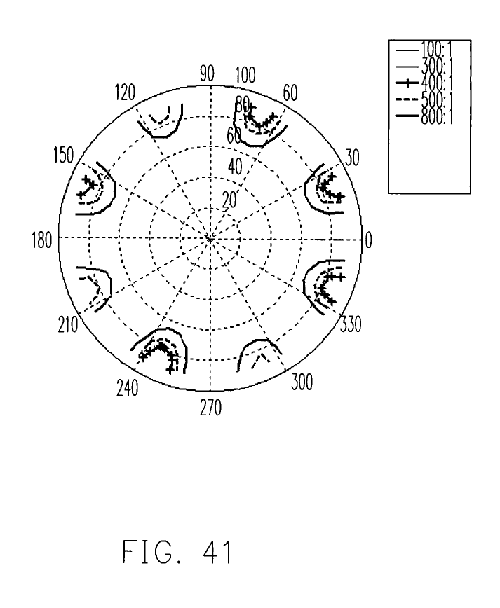

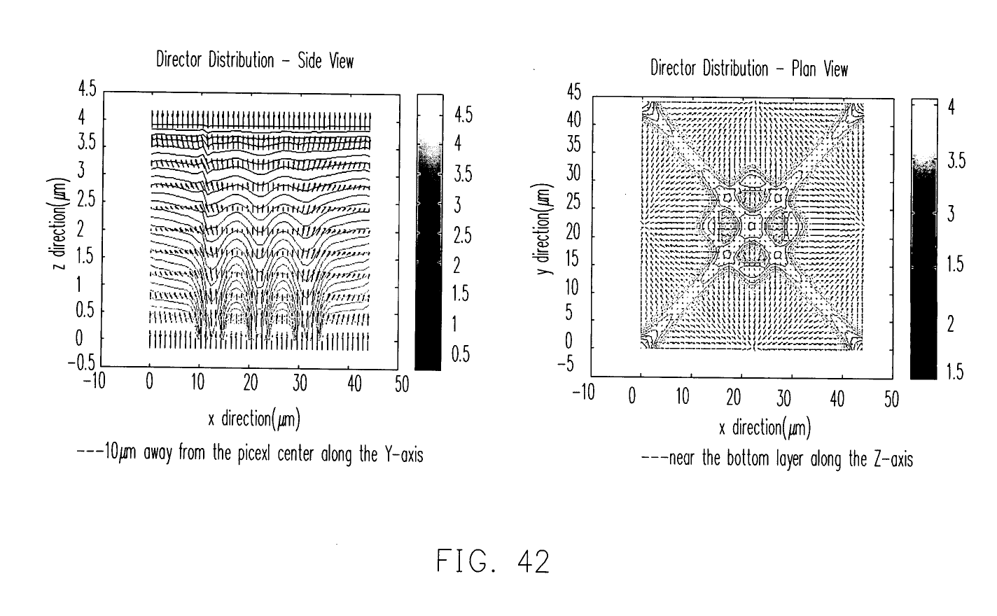

For the exemplary aim, an a-plate compensation film is added at the d·n value of 64.8 nm before the linear polarizer, and a pair of a-plate and c-plate compensation films are added at the d·n value of 119.2 nmnm and 168.5 nm after the linear analyzer respectively. The contrast ratio is calculated between 0 Vᵣₘₛ and 5 Vᵣₘₛ. As shown in FIG. 41, the device has a high contrast ratio of 800:1 in the range of ±70°. The iso-contrast contour of 400:1 on both the right-left region and the up-down region has been reaching out of ±80°, which demonstrates that the device has a wide view angle of above 1600 even with an excellent contrast ratio of 400:1. Therefore, the embodiment of the VA mode LCD device has a high contrast ratio of 800:1 and the very wide view angle ability better than 400:1 on the whole view range.

### EXAMPLE 9

An embodiment of a display device using linear polarizers or circular polarizers (FIG. 1A or FIG. 1B) and having the cross-shaped opening 302 in the pixel electrode 208 (as shown in FIG. 29) is described, wherein the central portion 302a of the cross-shaped opening 302 is a serial of ring-shaped openings around the center of the extending portions 302b and the ring-shaped openings are 8 μm away from the center of the pixel unit with the equal outer side length of 7 μm. The other conditions, such as pixel unit size, cell gap between the two substrates, and LC materials, are the same or similar to those described in Example 7.

FIG. 42 is the simulated LC director distribution of Example 9 when the applied voltage is 5Vᵣₘₛ between the common electrode and pixel electrode. From the side view, it can be observed that the LC directors are reoriented along the electric field direction due to the fringing field effect. On the plan view, it can be seen that the LC directors have been divided into different evident domains in the pixel unit. The domains are broken and met at the midpoint of each side of the tetragonal shaped pixels and the disclination lines are mostly eliminated. Therefore, an embodiment of a multi-domain VA mode LCD device has been formed from the cross-shaped opening under the application of electric field and it is nearly disclination-line free.

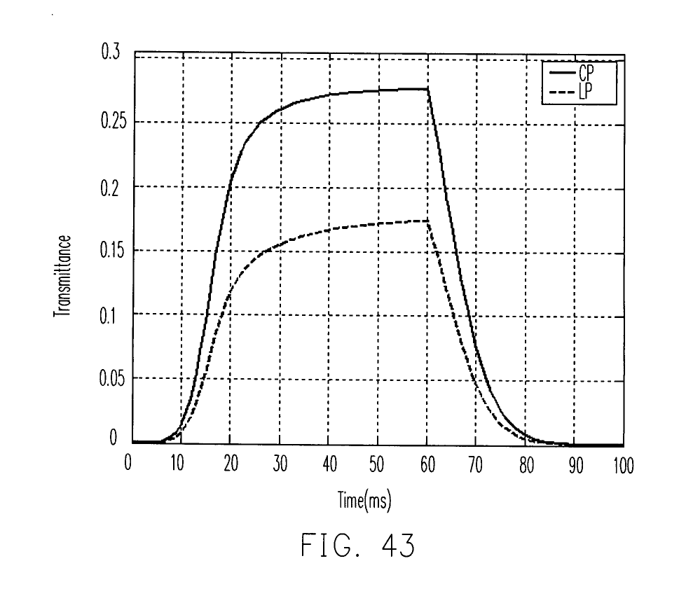

FIG. 43 is the time-dependent transmittance of the VA mode LCD device of Example 9 under the linear polarizers and the circular polarizers, respectively. The transmittance of the VA mode LCD device is 17.5% under the linear polarizers which is higher than that of the conventional PVA modes as discussed in Example 7. When the circular polarizers are used, the transmittance has increased to 27.7% under the circular polarizers, which is 58% improvement than that of the linear polarizers. Therefore, the light transmittance of the VA mode can be greatly improved when the circular polarizers are adopted.

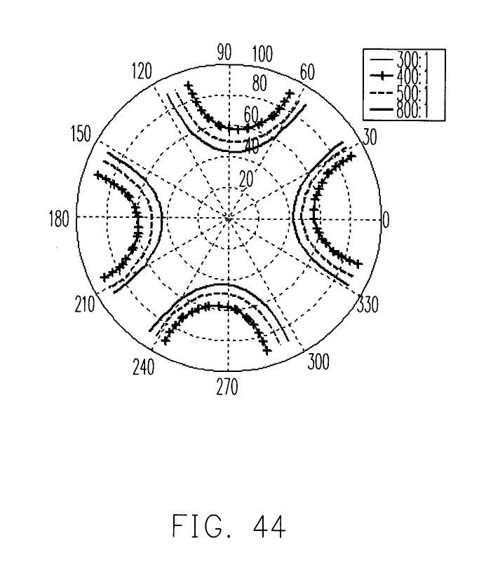

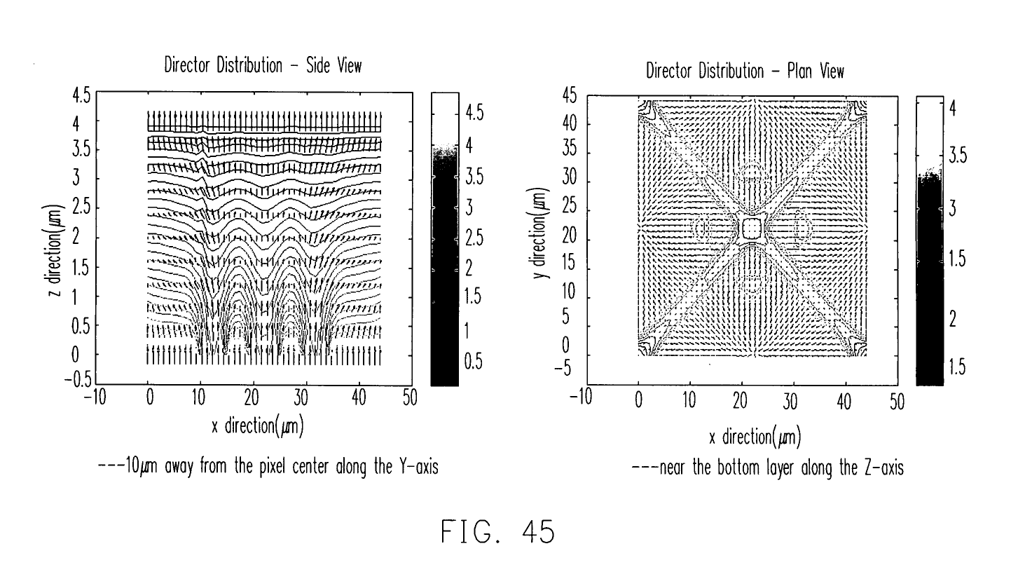

As an example, a set of a-plate and c-plate compensation films are added at the d·n value of 97.9 nm and 12.2 nm, and 112.4 nm and 134.6 nm, before and after the linear polarizer and analyzer respectively. The contrast ratio is calculated between 0 Vᵣₘₛ and 5Vᵣₘₛ As shown in FIG. 44, the device has a high contrast ratio nearby the center area that is better than 800:1. The iso-contrast contour of 800:1 is larger than ±40° and symmetric to all the directions. The iso-contrast contour of 100:1 on both the right-left region and the up-down region has been reaching out of ±80°, which demonstrates that the device has a wide view angle of above 160°even with an excellent contrast ratio of 100:1. Therefore, this embodiment of the VA mode LCD device has a high contrast ratio of 800:1 and the very wide view angle ability.

### EXAMPLE 10

An embodiment of a display device using linear polarizers or circular polarizers (FIG. 1A or FIG. 1B) and having the cross-shaped opening 302 in the pixel electrode 208 (as shown in FIG. 30), wherein the central portion 302a of the cross-shaped opening 302 is a serial of smaller intra-triangle openings around the center of the extending portions 302b, and the tip of the intra-triangle opening is pointing away from the center of the pixel unit. The intra-triangle openings are 8 μm away from the center of the pixel unit with the equal side length of 8 μm. The other conditions, such as pixel unit size, cell gap between the two substrates, and LC materials, are the same or similar to those described in Example 7.

FIG. 45 is the simulated LC director distribution of Example 10 when the applied voltage is 5Vᵣₘₛ between the common electrode and pixel electrode. From the side view, it can be observed that the LC directors are reoriented along the electric field direction due to the fringing field effect. On the plan view, it can be seen that the LC directors have been divided into different evident domains in the pixel unit. The domains are broken and met at the midpoint of each side of the tetragonal shaped pixels and the disclination lines are mostly eliminated. Therefore, an embodiment of a multi-domain VA mode LCD device has been formed from the cross-shaped opening under the application of electric field and it is nearly disclination-line free.

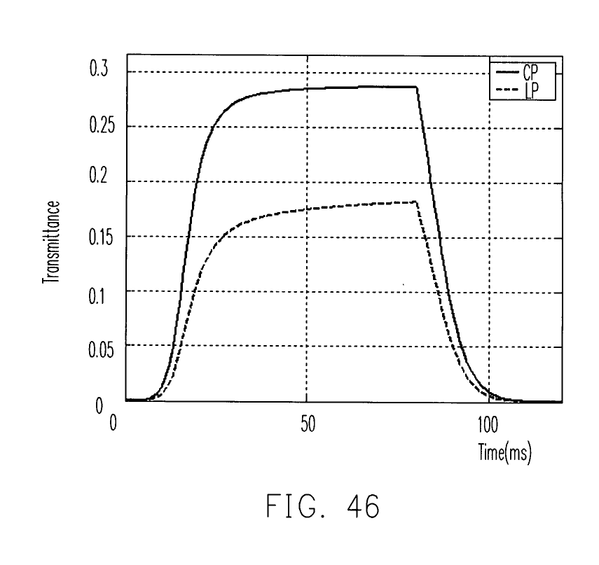

FIG. 46 is the time-dependent transmittance of the VA mode LCD device of Example 10 under the linear polarizers and the circular polarizers, respectively. The transmittance of the VA mode LCD device is 18.2% under the linear polarizers which is higher than that of the conventional PVA modes as discussed in Example 7. When the circular polarizers are used, the transmittance has increased to 28.7% under the circular polarizers, which is 57.7% improvement than that of the linear polarizers. Therefore, the light transmittance of the VA mode can be greatly improved when the circular polarizers are adopted.

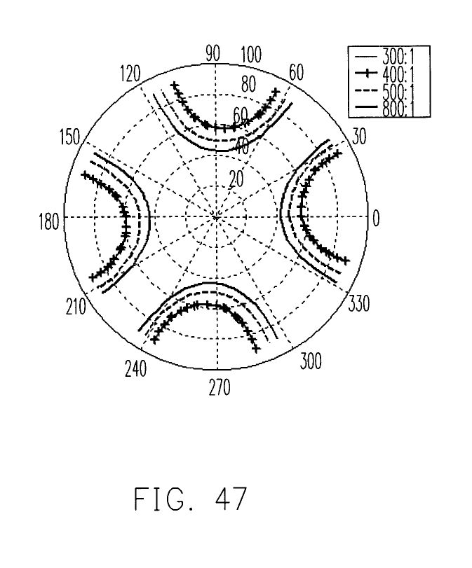

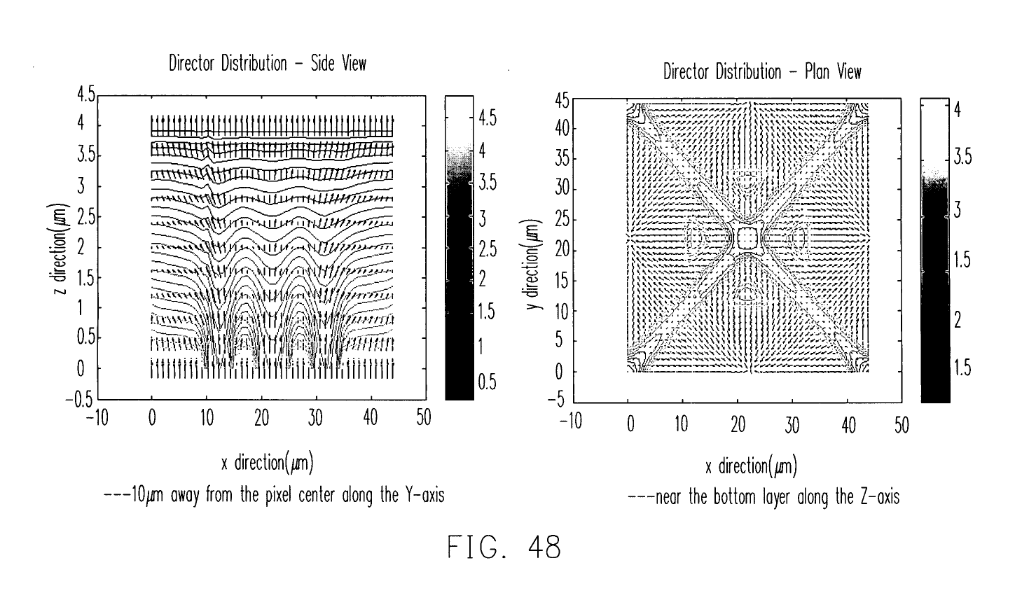

As the exemplary aim, a set of a-plate and c-plate compensation films are added at the d·n value of 98.2 nm and 12.3 nm, and 112 nm and 134.6 nm, before and after the linear polarizer and analyzer respectively. The contrast ratio is calculated between 0 Vᵣₘₛ and 5Vᵣₘₛ . As shown in FIG. 47, the device has a high contrast ratio nearby the center area that is better than 800:1 . The iso-contrast contour of 800:1 is larger than ±40° and symmetric to all the directions. The iso-contrast contour of 100:1 on both the right-left region and the up-down region has been reaching out of ±80°, which demonstrates that the device has a wide view angle of above 160° even with an excellent contrast ratio of 100:1. Therefore, this embodiment of the VA mode LCD device has a high contrast ratio of 800:1 and the very wide view angle ability.

### EXAMPLE 11

An embodiment of a display device using linear polarizers or circular polarizers (FIGS. 1A or FIG. 1B) and having the cross-shaped opening 302 in the pixel electrode 208 (as shown in FIG. 31) is described, wherein the central portion 302a of the cross-shaped opening 302 is a serial of smaller intra-triangle openings around the center of the extending portions 302b, and the tip of the intra-triangle opening is pointing at the center of the pixel unit. The intra-triangle openings are 8 μm away from the center of the pixel unit with the equal side length of 8 μm. The other conditions, such as pixel unit size, cell gap between the two substrates, and LC materials, are the same or similar to those described in Example 7.

FIG. 48 is the simulated LC director distribution of Example 11 when the applied voltage is 5Vᵣₘₛ between the common electrode and pixel electrode. From the side view, it can be observed that the LC directors are reoriented along the electric field direction due to the fringing field effect. On the plan view, it can be seen that the LC directors have been divided into different evident domains in the pixel unit. The domains are broken and met at the midpoint of each side of the tetragonal shaped pixels and the disclination lines are mostly eliminated. Therefore, an embodiment of a multi-domain VA mode LCD device has been formed from the cross-shaped opening under the application of electric field and it is nearly disclination-line free.

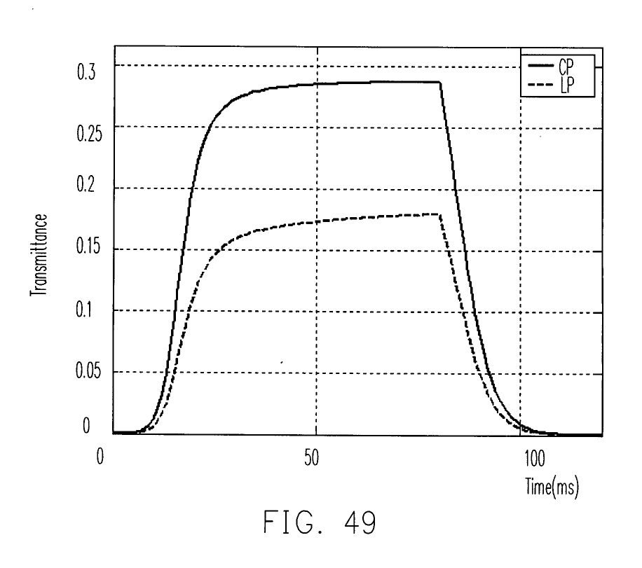

FIG. 49 is the time-dependent transmittance of the VA mode LCD device of Example 11 under the linear polarizers and the circular polarizers, respectively. The transmittance of the VA mode LCD device is 18% under the linear polarizers which is higher than that of the conventional PVA modes as discussed in Example 7. When the circular polarizers are used, the transmittance has increased to 28.7% under the circular polarizers, which is 59% improvement than that of the linear polarizers. Therefore, the light transmittance of the VA mode can be greatly improved when the circular polarizers are adopted.

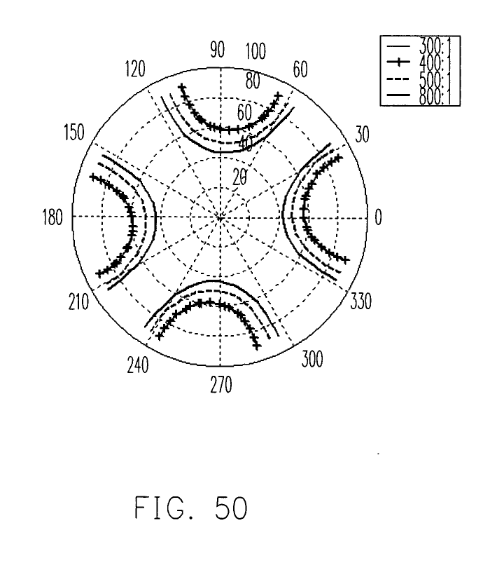

As the exemplary aim, a set of a-plate and c-plate compensation films are added at the d·n value of 98.1 nm and 12.5 nm, and 112.8 nm and 134.4 nm, before and after the linear polarizer and analyzer respectively. The contrast ratio is calculated between 0 Vᵣₘₛ and 5Vᵣₘₛ. As shown in FIG. 50, the device has a high contrast ratio nearby the center area that is better than 800:1. The iso-contrast contours of 800:1 is larger than ±40° and symmetric to all the directions. The iso-contrast contours of 100:1 on both the right-left region and the up-down region has been reaching out of ±80°, which demonstrates that the device has a wide view angle of above 160° even with an excellent contrast ratio of 100:1. Therefore, an embodiment of the VA mode LCD device has a high contrast ratio of 800:1 and the very wide view angle ability.

### EXAMPLE 12

An embodiment of a display device using linear polarizers or circular polarizers (FIGS. 1A or FIG. 1B) and having the cross-shaped opening 302 in the pixel electrode 208 (as shown in FIG. 32) is described, wherein the central portion 302a of the cross-shaped opening 302 is a serial of smaller intra-quadrilateral openings around the center of the extending portions 302b, and the intra-quadrilateral openings are the quadrangular ones with the side length of 6 μm. The other conditions, such as pixel unit size, cell gap between the two substrates, and LC materials, are the same or similar to those described in Example 7.

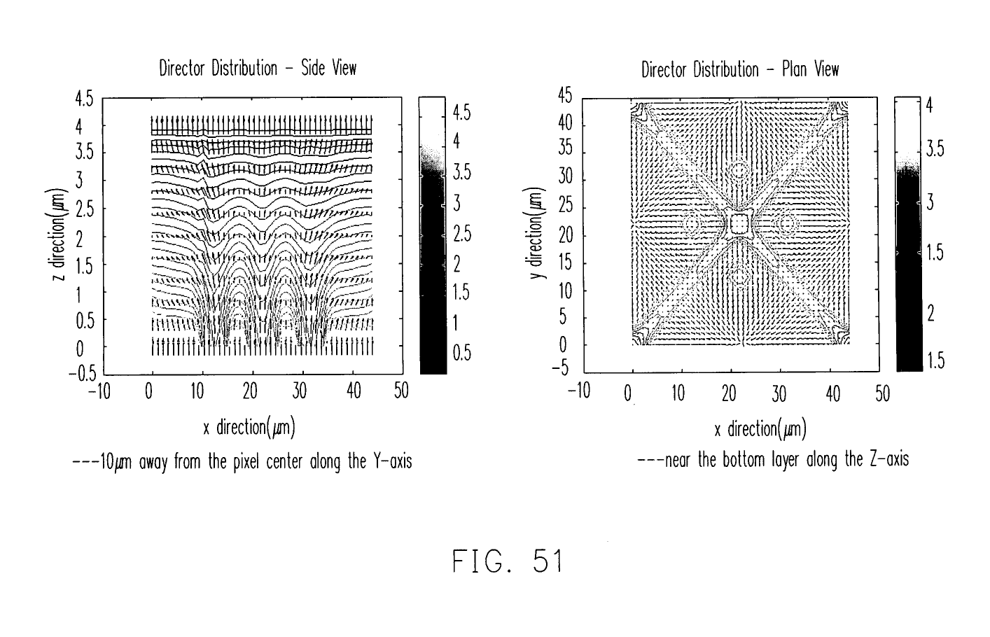

FIG. 51 is the simulated LC director distribution of Example 12 when the applied voltage is 5Vᵣₘₛ between the common electrode and pixel electrode. From the side view, it can be observed that the LC directors are reoriented along the electric field direction due to the fringing field effect. On the plan view, it can be seen that the LC directors have been divided into different evident domains in the pixel unit. The domains are broken and met at the midpoint of each side of the tetragonal shaped pixels and the disclination lines are mostly eliminated. Therefore, a multi-domain LCD device has been formed from the cross-shaped opening under the application of electric field and it is nearly disclination-line free.

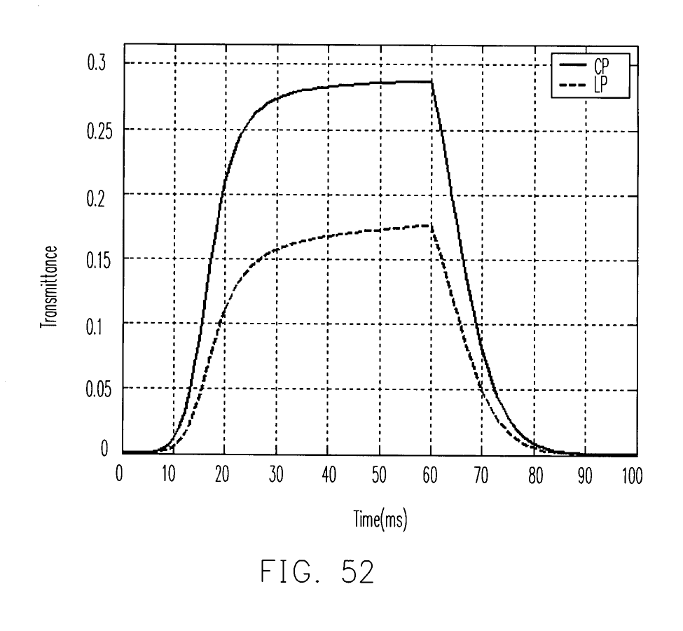

FIG. 52 is the time-dependent transmittance of the VA mode LCD device of Example 12 under the linear polarizers and the circular polarizers, respectively. The transmittance of the VA mode LCD device is 17.5% under the linear polarizers which is higher than that of the conventional PVA modes as discussed in Example 7. When the circular polarizers are used, the transmittance has increased to 28.6% under the circular polarizers, which is 63% improvement than that of the linear polarizers. Therefore, the light transmittance of the VA mode can be greatly improved when the circular polarizers are adopted.

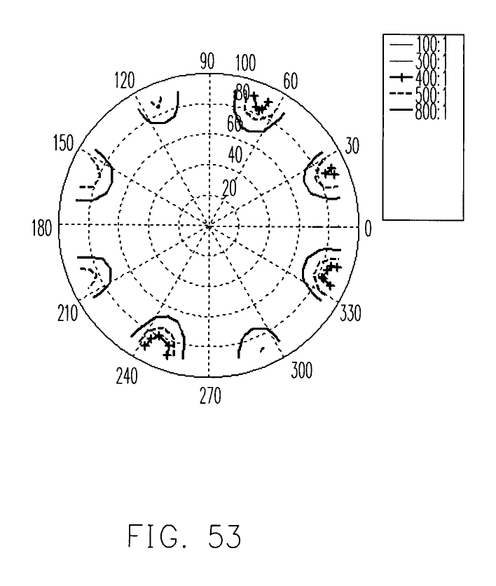

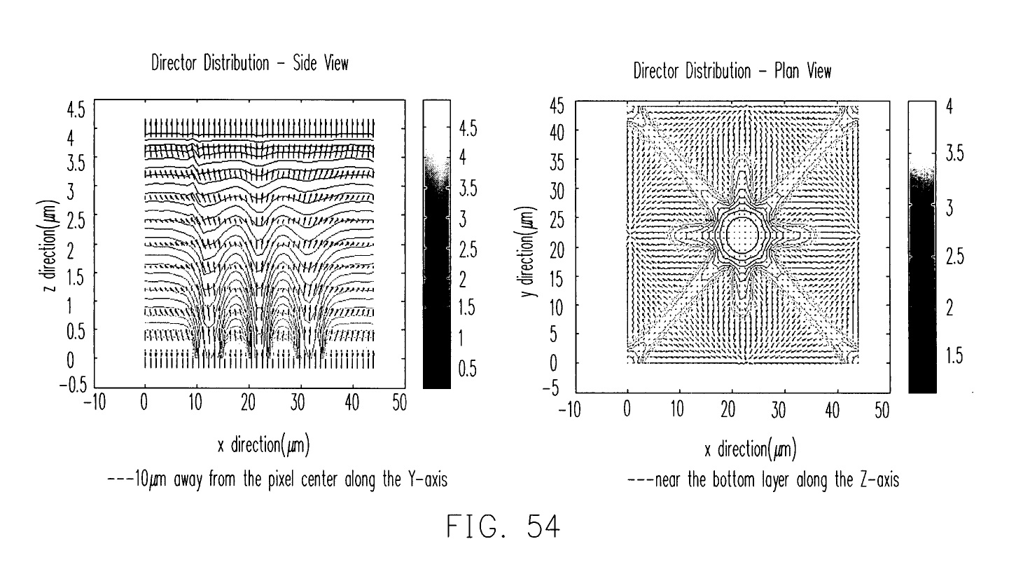

As the exemplary aim, an a-plate compensation film is added at the d·n value of 64.4 nm before the linear polarizer, and a pair of a-plate and c-plate compensation films are added at the d·n value of 119.5 nmnm and 168.5 nm after the linear analyzer respectively. The contrast ratio is calculated between 0 Vᵣₘₛ and 5 Vᵣₘₛ. As shown in FIG. 53, the device has a high contrast ratio of 800:1 in the range of ±700°. The iso-contrast contour of 400:1 on both the right-left region and the up-down region has been reaching out of ±80°, which demonstrates that the device has a wide view angle of above 160° even with an excellent contrast ratio of 400:1 . Therefore, this embodiment of the VA mode LCD device has a high contrast ratio of 800:1 and the very wide view angle ability better than 400:1 on the whole view range.

### EXAMPLE 13

An embodiment of a display device using linear polarizers or circular polarizers (FIGS. 1A or FIG. 1B) and having the cross-shaped opening 302 in the pixel electrode 208 (as shown in FIG. 33) is described, wherein the central portion 302a of the cross-shaped opening 302 is a serial of shorter stripe-shaped openings around the center of the extending portions 302b, and stripe-shaped openings are with the width of 4 μm and the length of 14 μm calculated from the pixel center position. The other conditions, such as pixel unit size, cell gap between the two substrates, and LC materials, are the same or similar to those described in Example 7.

FIG. 54 is the simulated LC director distribution of Example 13 when the applied voltage is 5Vᵣₘₛ between the common electrode and pixel electrode. From the side view, it can be observed that the LC directors are reoriented along the electric field direction due to the fringing field effect. On the plan view, it can be seen that the LC directors have been divided into different evident domains in the pixel unit. The domains are broken and met at the midpoint of each side of the tetragonal shaped pixels and the disclination lines are mostly eliminated. Therefore, a multi-domain LCD device has been formed from the cross-shaped opening under the application of electric field and it is nearly disclination-line free.

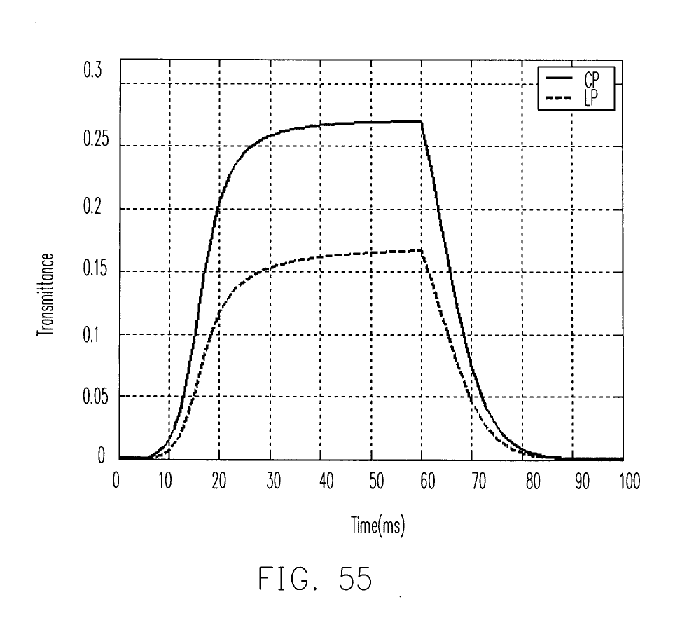

FIG. 55 is the time-dependent transmittance of the VA mode LCD device of Example 13 under the linear polarizers and the circular polarizers, respectively. The transmittance of the VA mode LCD device is 16.7% under the linear polarizers which is higher than that of the conventional PVA modes as discussed in Example 7. When the circular polarizers are used, the transmittance has increased to 27% under the circular polarizers, which is 61.7% improvement than that of the linear polarizers. Therefore, the light transmittance of the VA mode can be greatly improved when the circular polarizers are adopted.

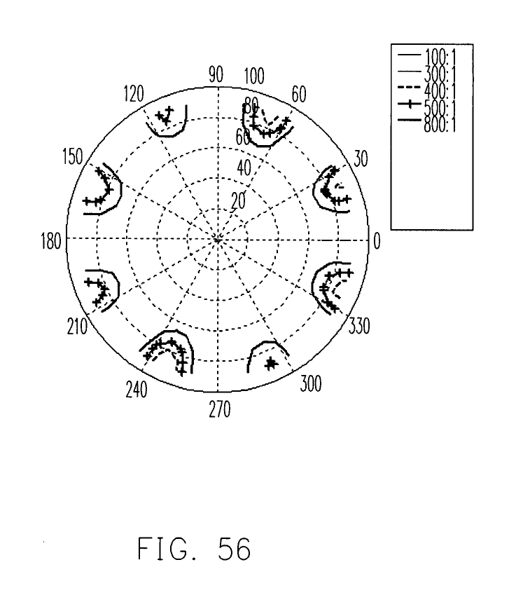

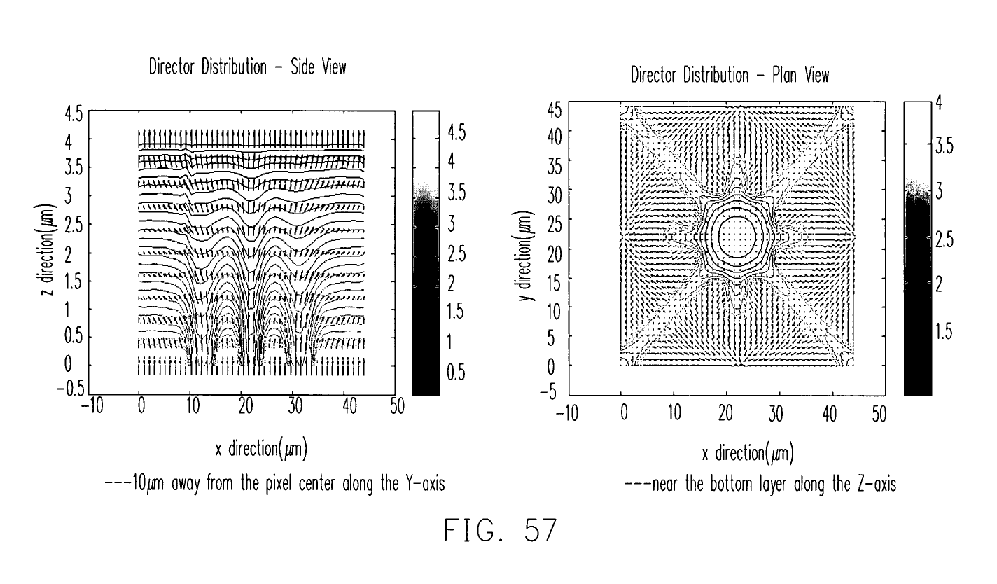

As the exemplary aim, an a-plate compensation film is added at the d·n value of 64.2 nm before the linear polarizer, and a pair of a-plate and c-plate compensation films are added at the d·n value of 119 nmnm and 168.2 nm after the linear analyzer respectively. The contrast ratio is calculated between 0 Vᵣₘₛ and 5 Vᵣₘₛ. As shown in FIG. 56, the device has a high contrast ratio of 800:1 in the range of ±70°. The iso-contrast contour of 400:1 on both the right-left region and the up-down region has been reaching out of ±80°, which demonstrates that the device has a wide view angle of above 160° even with an excellent contrast ratio of 400:1. Therefore, this embodiment of the VA mode LCD device has a high contrast ratio of 800:1 and the very wide view angle ability better than 400:1 on the whole view range.

### EXAMPLE 14

An embodiment of a display device using linear polarizers or circular polarizers (FIGS. 1A or FIG. 1B) and having the cross-shaped opening 302 in the pixel electrode 208 (as shown in FIG. 34) is described, wherein the central portion 302a of the cross-shaped opening 302 is constituted of a quadrangular opening in the center of the extending portions 302b and a serial of shorter stripe-shaped openings connected with the quadrangular opening. The stripe-shaped openings are with the width of 4 μm and the length of 14 μm calculated from the pixel center position. The centered quadrangular opening is with the equal side length of 14 μm. The other conditions, such as pixel unit size, cell gap between the two substrates, and LC materials, are the same or similar to those described in Example 7.

FIG. 57 is the simulated LC director distribution of Example 14 when the applied voltage is 5Vᵣₘₛ between the common electrode and pixel electrode. From the side view, it can be observed that the LC directors are reoriented along the electric field direction due to the fringing field effect. On the plan view, it can be seen that the LC directors have been divided into different evident domains in the pixel unit. The domains are broken and met at the midpoint of each side of the tetragonal shaped pixels and the disclination lines are mostly eliminated. Therefore, an embodiment of a multi-domain LCD device has been formed from the cross-shaped opening under the application of electric field and it is nearly disclination-line free.

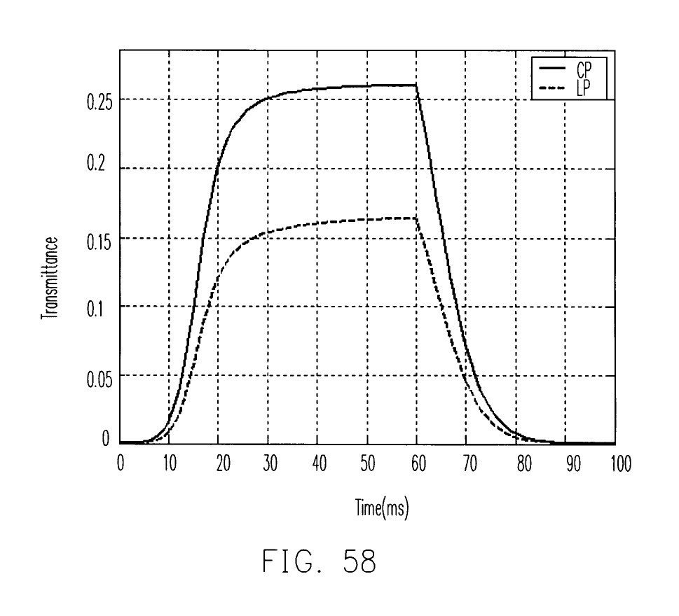

FIG. 58 is the time-dependent transmittance of the VA mode LCD device of Example 14 under the linear polarizers and the circular polarizers, respectively. The transmittance of the VA mode LCD device is 16.4% under the linear polarizers which is higher than that of the conventional PVA modes as discussed in Example 7. When the circular polarizers are used, the transmittance has increased to 26.1% under the circular polarizers, which is 59% improvement than that of the linear polarizers. Therefore, the light transmittance of the VA mode can be greatly improved when the circular polarizers are adopted.

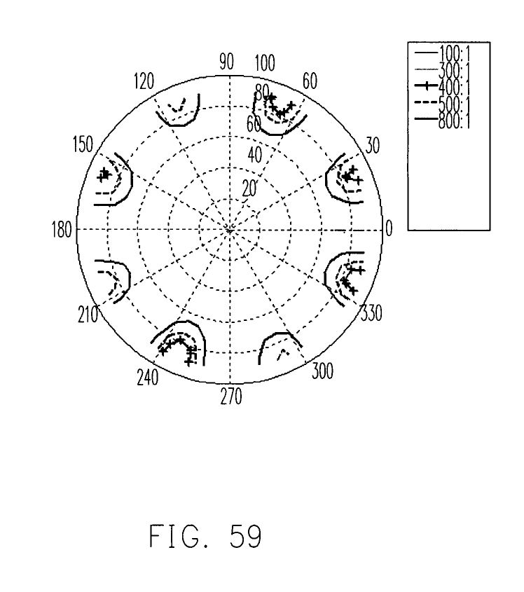

As the exemplary aim, an a-plate compensation film is added at the d·n value of 64.3 nm before the linear polarizer, and a pair of a-plate and c-plate compensation films are added at the d·n value of 119.3 nmnm and 168.1 nm after the linear analyzer respectively. The contrast ratio is calculated between 0 Vᵣₘₛ and 5Vᵣₘₛ. As shown in FIG. 59, the device has a high contrast ratio of 800:1 in the range of ±70°. The iso-contrast contour of 400:1 on both the right-left region and the up-down region has been reaching out of ±80°, which demonstrates that the device has a wide view angle of above 160° even with an excellent contrast ratio of 400:1 . Therefore, in addition to its high transmittance and faster response time, the advantages of the super-wide view angle and high contrast ratio may make this embodiment of the VA mode LCD device particularly beneficial for LC TV and monitor applications.

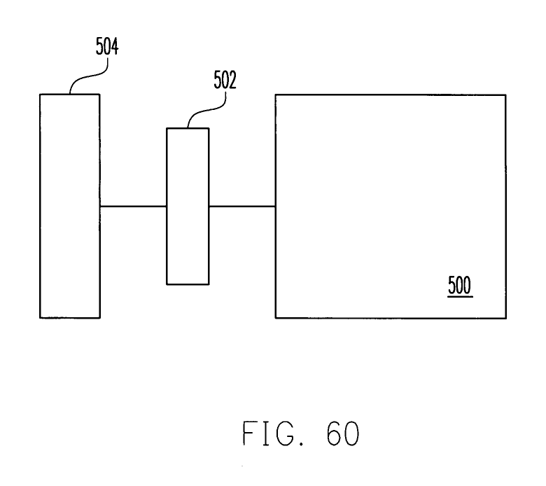

In the present invention, electronic devices using embodiments of the VA mode LCD device such as mentioned above also are provided. FIG. 60 is a drawing showing an electronic device according to one such embodiment. The electronic device may comprise a LCD display 500, a controller 502 and an input device 504. The LCD display 500 may be similar to the vertical alignment liquid crystal display of FIG. 1A or FIG. 1B having various shapes of openings as above mentioned. The controller 502 may be electrically coupled to the LCD display 500. The controller 502 may comprise a source and a gate driving circuits (not shown) to control the LCD display 500 to render image in accordance with an input. The input device 504 may be electrically coupled to the controller 502 and may include a processor or the like to input data to the controller 502 to render an image on the LCD display 500.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for displaying images comprising:
a vertical alignment liquid crystal display having a pixel unit comprising:
a first substrate comprising a pixel layer thereon, wherein the pixel layer comprises a thin film transistor and a pixel electrode;
a second substrate comprising a common electrode thereon; and
a liquid crystal layer between the first and second substrates,
wherein both the pixel electrode and the common electrode have a plurality of holes therein, and the holes in the pixel electrode are located to not align vertically with the holes in the common electrode.

2. The system according to claim 1, wherein the holes are hexagonal in shape.

3. The system according to claim 1, further comprising two polarizers, one of which is disposed on an exterior surface of the first substrate, and another of which is disposed on an exterior surface of the second substrate.

4. The system according to claim 3, wherein the polarizers are linear polarizers.

5. The system according to claim 3, wherein the polarizers are circular polarizers, and each of the circular polarizers comprises a linear polarizer and a broadband quarter wave film.

6. The system according to claim 3, further comprising at least one compensation film disposed between one of the polarizers and one of the first and second substrates.

7. The system according to claim 1, further comprising a color filter layer between the second substrate and the common electrode.

8. A system for displaying images comprising:
a vertical alignment liquid crystal display comprising pixel units, wherein each of a plurality of the pixel units comprises:
a first substrate comprising a pixel layer thereon, wherein the pixel layer comprises a thin film transistor and a pixel electrode;
a second substrate comprising a common electrode thereon; and
a liquid crystal layer between the first and second substrates,
wherein one of the pixel electrode and the common electrode has a cross-shaped opening therein, and the cross-shaped opening includes a central portion and extending portions extending from the central portion.

9. The system according to claim 8, wherein the central portion of the cross-shaped opening comprises triangle-shaped openings extending between adjacent ones of the extending portions.

10. The system according to claim 8, wherein the central portion of the cross-shaped opening is a circular-shaped opening.

11. The system according to claim 8, wherein the central portion of the cross-shaped opening is a series of intra-quadrilateral openings.

12. The system according to claim 11, wherein each of the intra-quadrilateral openings has a tip pointing at the center of the pixel unit.

13. The system according to claim 8, wherein the central portion of the cross-shaped opening comprises a quadrangular opening in the center of the extending portions and a series of shorter stripe-shaped openings connected to the quadrangular opening.

14. The system according to claim 8, further comprising two polarizers disposed on exterior surfaces of the first and second substrates, respectively.

15. The system according to claim 14, wherein the polarizers are linear polarizers.

16. The system according to claim 14, wherein the polarizers are circular polarizers, and each of the circular polarizers comprises a linear polarizer and a broadband quarter wave film.

17. The system according to claim 14, further comprising at least one compensation film disposed between one of the polarizers and one of the first and second substrates.

18. The system according to claim 8, further comprising a color filter layer between the second substrate and the common electrode.

19. A system for displaying images comprising:
an electronic device, comprising:
a vertical alignment liquid crystal display having a pixel unit comprising:
a first substrate comprising a pixel layer thereon, wherein the pixel layer comprises a thin film transistor and a pixel electrode;
a second substrate comprising a common electrode thereon; and
a liquid crystal layer between the first and second substrates,
wherein both the pixel electrode and the common electrode have a plurality of holes therein, and the holes in the pixel electrode are located to not align vertically with the holes in the common electrode; and
a controller electrically coupled to the display.

20. A system for displaying images comprising:
an electronic device, comprising:
a vertical alignment liquid crystal display having a pixel unit comprising:
a first substrate comprising a pixel layer thereon, wherein the pixel layer comprises a thin film transistor and a pixel electrode;
a second substrate comprising a common electrode thereon; and
a liquid crystal layer between the first and second substrates,
wherein one of the pixel electrode and the common electrode has a cross-shaped opening therein, and the cross-shaped opening includes a central portion and extending portions extending from the central portion; and
a controller electrically coupled to the display.

21. The system according to claim 19, further comprising:
an input device electrically coupled to the controller to render an image on the display.

22. The system according to claim 20, further comprising:
an input device electrically coupled to the controller to render an image on the display.
